(19) United States
(12) Patent Application Publication
(10) Pub. No.: US 2009/0248552 A1
(43) Pub. Date: Oct. 1, 2009

(54) REAL-TIME TIME AND ATTENDANCE SYSTEM

(75) Inventors: John Richard Taylor, Reno, NV (US); Ann Irene Nygren, Reno, NV (US)

Correspondence Address: SILVERSKY GROUP LLC, 5422 LONGLEY LANE, SUITE B, RENO, NV, 89511, US

(73) Assignee: KEYOLOGY, LLC, Reno, NV (US)

(21) Appl. No.: 12/413,331

(22) Filed: Mar. 27, 2009

Related U.S. Application Data
(60) Provisional application No. 61/072,235, filed on Mar. 28, 2008.

(51) Int. Cl. G06Q 10/00; G06F 17/30

(52) U.S. Cl. 705/32; 707/3; 235/377; 707/E17.108

(57) ABSTRACT

The present invention is directed to one or more time and attendance systems specifically designed for use in the gaming (gambling) and hospitality (hotels and restaurants) industries, but may additionally be utilized advantageously in a wide range of other fields or industries. The disclosed time and attendance system can be easily integrated into existing human resource software systems so as to eliminate duplication of employee records and duplication of servers. The disclosed time and attendance system combines a time clock apparatus that allows employees and supervisors to clock in and clock out, view records of their accumulated time, etc., with a behind the clock software system that allows persons with proper authorization to configure the time clock apparatus and to review, approve, disapprove and/or edit employee time clock records in a simple and organized manner.

### CROSS-REFERENCES TO RELATED APPLICATIONS

This is a utility patent application, taking priority from provision patent application Ser. No. 61/072,235, filed Mar. 28, 2008, which is incorporated herein in its entirety.

### BRIEF DESCRIPTION OF THE INVENTION

The present invention is directed to time and attendance systems for use in large-scale organizations to record, track, and analyze human workforce costs and efficiencies on a platform that seamlessly integrates with the most popular human resources software.

### STATEMENT AS TO THE RIGHTS TO INVENTIONS MADE UNDER FEDERALLY SPONSORED RESEARCH OR DEVELOPMENT

Not Applicable.

### REFERENCE TO A “SEQUENCE LISTING,” A TABLE, OR A COMPUTER PROGRAM LISTING APPENDIX SUBMITTED ON A COMPACT DISK

Not Applicable.

### BACKGROUND OF THE INVENTION

Service industries and large scale organizations, in general, rely upon many employees working simultaneously to cater to customer needs. These employees need to be paid, tracked, and analyzed so that organizations can evaluate employee performance and efficiency.

Many time clock systems have been developed over the years. Mechanical punch-card type time clock systems utilize a heavy paper card, called a time card, which an employee inserts into a slot on a time clock. When the time card hits a contact at the rear of the slot, the machine prints day and time information on the card. This allows a timekeeper to have an official record of the hours an employee worked to calculate and pay the employee. Because these systems are mechanical they do not easily enable real time review and editing of clocked hours.

Electrical time clock systems have been developed more recently. On these electrical and/or digital systems, the employee can enter an employee number, swipe a magnetic stripe card, swipe a bar coded card, or bring an RFID tag into proximity of a reader, or use some other device to identify the employee to the system. Based on the system being used, the employee can then enter information to be recorded. This information could include “punching in”, “punching out”, lunch breaks, and other types of information the employer requests.

In recent years complex human resource software has been developed to facilitate operating large scale organizations that employ hundreds or thousands of service personnel. For example, the INFOR/INFINIUM HUMAN CAPITAL MANAGEMENT system and the IBM SYSTEMS i system can be used by organizations to optimize the entire recruit-to-retire process that an employee may move through throughout a career and to enable effective workforce decision-making.

It would be advantageous to combine organization-wide networked time clock systems with real time manager review capabilities, while utilizing employee records created and maintained with an organization's existing human resource software.

### BRIEF DESCRIPTION OF THE SEVERAL VIEWS OF THE DRAWING

FIG. 1 illustrates an exemplary embodiment of a time clock apparatus in accordance with the present invention;

FIG. 2 illustrates a schematic diagram of an exemplary time and attendance system in accordance with the present invention;

FIG. 3 illustrates an exemplary embodiment of a default employee screen of the time and attendance system, in accordance with the present invention;

FIG. 4 illustrates an exemplary embodiment of an employee clock in screen of the time and attendance system, in accordance with the present invention;

FIG. 5 illustrates an exemplary embodiment of a complete transaction screen of the time and attendance system, in accordance with the present invention;

FIG. 6 illustrates an exemplary embodiment of a clock out screen of the time and attendance system, in accordance with the present invention;

FIG. 7 illustrates an exemplary embodiment of an hours clocked screen of the time and attendance system, in accordance with the present invention.

FIG. 8 illustrates an exemplary embodiment of a clock messages screen of the time and attendance system, in accordance with the present invention;

FIG. 9 illustrates an exemplary embodiment of a clock messages screen displaying a requirement expiring message, in accordance with the present invention;

FIG. 10 illustrates an exemplary embodiment of a supervisor override screen of the time and attendance system, in accordance with the present invention;

FIG. 11 illustrates an exemplary embodiment of a supervisor PIN screen of the time and attendance system, in accordance with the present invention;

FIG. 12 illustrates an exemplary embodiment of a job change screen of the time and attendance system, in accordance with the present invention;

FIG. 13 illustrates an exemplary;embodiment of a complete transaction screen of the time and attendance system, in accordance with the present invention;

FIG. 14 illustrates an exemplary embodiment of a job change complete transaction screen of the time and attendance system, in accordance with the present invention;

FIG. 15 illustrates an exemplary embodiment of a supervisor hours override screen of the time and attendance system, in accordance with the present invention;

FIG. 16 illustrates an exemplary embodiment of an override complete transaction screen of the time and attendance system, in accordance with the present invention;

FIG. 17 illustrates an exemplary embodiment of a special event screen of the time and attendance system, in accordance with the present invention;

FIG. 18 illustrates an exemplary embodiment of a special events jobs screen of the time and attendance system, in accordance with the present invention;

FIG. 19 illustrates an exemplary embodiment of a declared tips entry screen of the time and attendance system, in accordance with the present invention;

FIG. 20 illustrates an exemplary embodiment of a tips declared complete transaction screen of the time and attendance system, in accordance with the present invention;

FIG. 21A illustrates an exemplary flow chart of the operation of a time clock apparatus of the time and attendance system, in accordance with the present invention;

FIG. 21B illustrates a continuation of the exemplary flow chart of the operation of a time clock apparatus of the time and attendance system, in accordance with the present invention;

FIG. 21C illustrates a continuation of the exemplary flow chart of the operation of a time clock apparatus of the time and attendance system, in accordance with the present invention;

FIG. 21D illustrates a continuation of the exemplary flow chart of the operation of a time clock apparatus of the time and attendance system, in accordance with the present invention;

FIG. 22A illustrates a continuation of the exemplary flow chart of the operation of a time clock apparatus of the time and attendance system, in accordance with the present invention;

FIG. 22B illustrates a continuation of the exemplary flow chart of the operation of a time clock apparatus of the time and attendance system, in accordance with the present invention;

FIG. 23A illustrates a continuation of the exemplary flow chart of the operation of a time clock apparatus of the time and attendance system, in accordance with the present invention;

FIG. 23B illustrates a continuation of the exemplary flow chart of the operation of a time clock apparatus of the time and attendance system, in accordance with the present invention;

FIG. 24 illustrates an exemplary embodiment of a maintain badge codes screen of the behind the clock system portion of the time and attendance system, in accordance with the present invention;

FIG. 25A illustrates an exemplary embodiment of a maintain shifts screen of the behind the clock system portion of the time and attendance system, in accordance with the present invention; and

FIG. 25B illustrates an exemplary embodiment of an add a shift screen of the behind the clock system portion of the time and attendance system, in accordance with the present invention.

### DETAILED DESCRIPTION OF THE INVENTION

The herein disclosed time and attendance system is specifically designed for use in the gaming (gambling) and hospitality (hotels and restaurants) industries, and may be utilized advantageously in a wide range of other fields or industries. Throughout this specification, the system will mostly be referred to as a gaming or hospitality system. But this specification intends to encompass the use of the disclosed time and attendance system in alternative fields or industries, as will be apparent to those skilled in the art. The time and attendance system can be easily integrated into existing human resource software systems, such as the Infor/Infinium Human Capital Management system or the IBM Systems i system mentioned above, for example, and/or with other organizational software systems, such as accounting, financial, or payroll system software, security software, communication systems (email), etc. The time and attendance system combines a time clock apparatus that allows employees and supervisors to clock in and clock out, view records of their accumulated time, etc., with a behind the clock software system that allows persons with proper authorization to configure the time clock apparatus, to review and approve or disapprove employee time clock records in an organized manner, etc.

The herein disclosed time and attendance system's time clock apparatus provides employees the ability to do any of the following, depending on their authorization level: use their personal ID badge and/or badge number to perform simple clock in and clock out functions; log-on and log-off breaks; log-on and log-off the gaming/hospitality property; declare tips; clock in and clock out of special events; change official jobs; receive personal, division level, and/or company level messages; receive messages regarding licenses or other required permits or other authorizations (referred to herein as “requirements”) that are about to expire or that have expired; view time clock messages in their primary language; and accept, dispute, and/or override clocked hours.

The herein disclosed time and attendance system's behind the clock software system provides authorized users with the ability to: set security access levels based on managers or supervisors authorities; set time and attendance system requirements in a hierarchical manner so that customization is allowed at a department level within the overall gaming/hospitality organization; adjust holidays and day light savings time, and their respective adjusted hourly pay rates; customize shifts, dual pay rates, differences in employee pay types (i.e. 10 hour shifts four days a week or eight hour shifts five days a week); create custom badge codes and authorizations; translate all time clock messages to almost any language; permit managers to have authority over any level of employee or custom group; set up special events and special event jobs, with active dates and inactive dates for the special events; instantaneously review employees who are on-property or those who are clocked in; review and approve (depending on authorization of the user) employees and their clocked hours at any time prior to payroll; run reports for exceptions, efficiency, comparisons, and other categories or classifications.

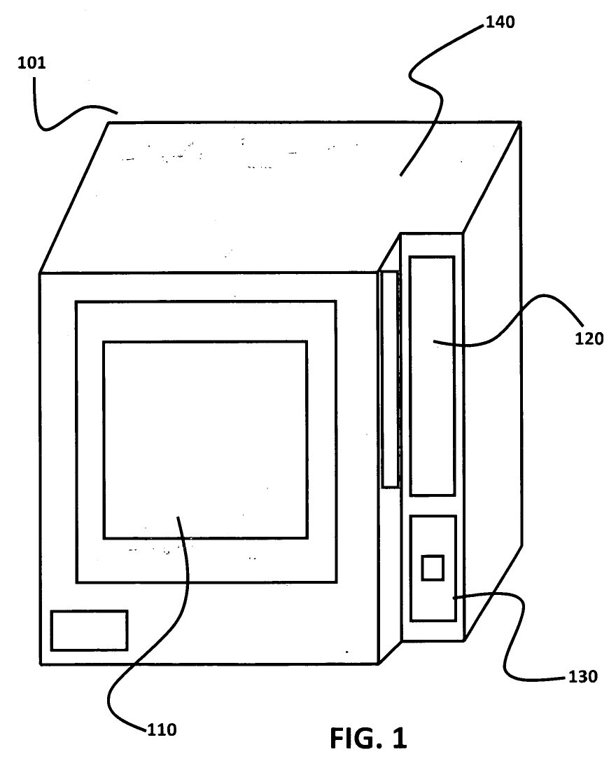

The time clock apparatus will first be explained. FIG. 1 illustrates a preferred embodiment of time clock apparatus 101. Time clock apparatus 101 may have an employee display screen 110, a card swipe 120, a biometric scanner/reader 130, and casing 140. Employee display screen 110 may be an interactive touch screen of any appropriate size that is capable of receiving input from an employee by recognizing touches on various parts of employee display screen 110. Employee display screen 110, which may alternatively be referred to as an interactive display screen, is preferable a color touch screen as is known in the art, but may alternatively be black-and-white or grayscale. Employee display screen 110 displays the various screens of the time and attendance system's GUI interface, as will be explained in more detail below. For example, employee display screen 110 can display virtual buttons which are capable of receiving various types of input from employee users or supervisor users.

Card swipe 120, which may alternatively be referred to as an identification device, may be capable of reading an employee's card when swiped through, as is known in the art. Many types of employee cards, or badges as they are alternatively referred to, and many types of card readers, may be utilized as card swipe 120. A preferred embodiment of the herein disclosed time and attendance system may incorporate an employee badge (or card) with a magnetized stripe storing that employee's badge number and a magnetized stripe reader at card swipe 120. Alternatively, the time and attendance system may incorporate an employee badge with a barcode that represents the employee's badge number and a barcode reader at card swipe 120. Those skilled in the art will appreciate that alternative badge and reader options may be appropriate.

Biometric scanner/reader 130 may be used either as an additional security feature in combination with card swipe 120, or in place of card swipe 120. Biometric scanner/reader 130 may be a commercially available thumbprint or fingerprint reader device for capturing the likeness of an employee's thumbprint or fingerprint. If the time clock apparatus is set up to utilize biometric scanner/reader 130 as an additional security measure, an employee may be prompted to insert his or her thumb or finger into the reader, or to swipe his or her thumb or finger through, or past, biometric scanner/reader 130. As is known in the art, the biometric scanner/reader 130 may compare the employee's thumbprint or fingerprint to stored thumbprints/fingerprints, or may compare portions of the employee's thumbprint or fingerprint, such as specific swirls, whorls, or patterns within a thumbprint or fingerprint, to previously recorded thumbprint or fingerprint portions. Alternatively, an electronic finger-print identification system or some other form of biometric scanner/reader may be substituted in place of a thumbprint/fingerprint reader at biometric scanner/reader 130.

Casing 140 may be water-resistant and/or corrosion-resistant. In a preferred embodiment, casing 140 is formed from a hard plastic material, but those skilled in the art will recognize that other materials, such as a variety of metals, may also be appropriate as casing 140. A top surface of casing 140 can be formed at an angle, slanted downward from the back edge to the front surface containing employee display screen 110. This slanted top surface, as seen in FIG. 1, is preferred because employees are known to place beverages atop existing time clocks. Those beverages often spill, potentially causing damage to the time clock and surrounding equipment. A slanted top surface, however, discourages this harmful practice and other inappropriate uses because beverage containers and other objects do not sit easily on a slanted surface. In other words, the slanted top surface can prevent certain objects from being placed on top of the time clock apparatus.

The entire time clock apparatus 101 shown in FIG. 1 would usually be wall-mounted at approximately shoulder height for ease of use. An employee utilizes time clock apparatus 101 by walking up to it and either swiping his or her badge through card swipe 120, or swiping his or her thumb/finger through biometric scanner/reader 130 depending on whether the gaming/hospitality organization has implemented additional biometric security. A WINDOWS XP (or other operating systems) GUI interface screen will then pop up on employee display screen 110 directing the employee to choose one or more of several options, as will be explained below. The time clock apparatus is connected to the overall organization's computer network by a standard 10/100 Mb Ethernet jack (RJ45) through a local LAN network or a direct connection. Alternatively, the time clock apparatus may be equipped with 802.11a/b/g devices for wireless connectivity into the overall network. Other methods or devices for connecting with a network are known in the art and may also be appropriate.

An organization utilizing the herein disclosed time and attendance system may incorporate more than one time clock apparatus. For example, an organization may have one time clock apparatus positioned in a kitchen area for use by restaurant and/or bar employees, one time clock apparatus positioned near a gaming floor for use by table game employees, and another time clock apparatus positioned at a maintenance shed for use by landscaping or maintenance employees. In this example, each of the time clock apparatuses would be connected to the overall network in real time so that all transactions carried out at each time clock apparatus would be recognized and recorded at a central location at the time of the transactions or action.

The time clock apparatuses are connectively coupled to the central server (and to behind the clock through the central server) in real time, as opposed to batch processing of time clock transactions at discrete time intervals, so that the time clock apparatus itself, and not just the central server, is constantly synced up with the overall time and attendance system. The central server includes a storage system for storing certain events occurring at the time clock apparatuses, such as clock in transactions and clock out transactions, as well as many other activities and events. Some of these events/activities are stored in a work record or employee record, as well as a transaction record (which might include the same things or different things). For example, on property transactions and off property transactions may only be stored in the transaction records, or in some other form in the storage system, while employee worked hours events are recorded in both the transaction record and the work record or employee record. Alternatively, a transaction record (or log) may store all transactions carried out at all time clock apparatuses by all employees and/or supervisors, while an employee record may store only those transactions carried out by a particular employee. The employee record may additionally store sets of hours worked by that employee.

A direct benefit to this real time connectivity is that once an employee user has clocked in to a time clock apparatus, that time clock apparatus will know immediately that the employee user is now clocked in. In this way, the time clock apparatus can prohibit or prevent the employee user from clocking in again (known as double-punching in the gaming/hospitality industry), because it already knows the employee has clocked in and has not clocked out or performed some other action, and instead only allow the previously-clocked in employee user to clock out or perform another appropriate transaction.

Additionally, employees newly added to the human resources software database or at behind the clock will immediately be recognized at the various time clock apparatuses scattered throughout the organization. Furthermore, software updates can be made at the central server (or at behind the clock) and can be immediately received by each time clock apparatus, even at the same time. Thus real time connectivity prevents a need to physically and separately install new software updates at each and every time clock apparatus throughout the organization. In this way, the organization can remotely modify the operation of the various time clock apparatuses placed throughout the organization by transmitting software updates through the central server. This remote modification can be done periodically or at specific times as needed.

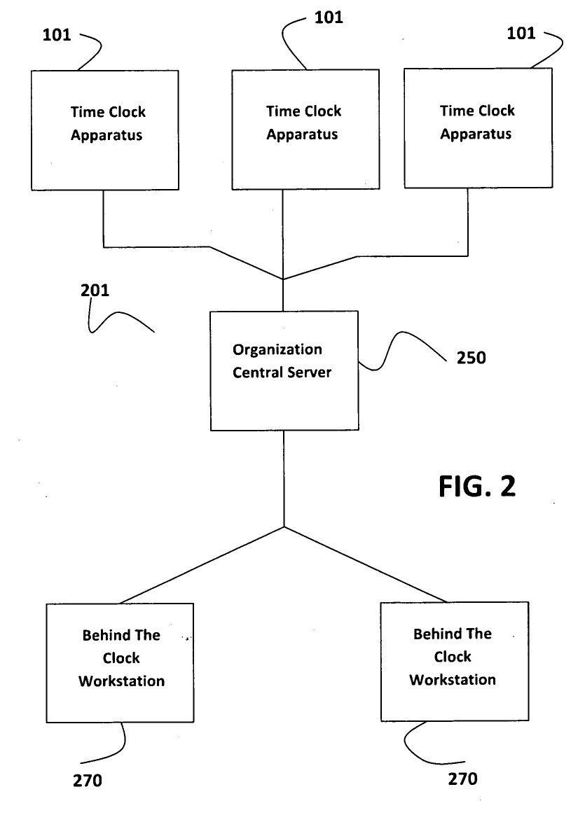

FIG. 2 schematically illustrates an example of an organization-wide network for the herein disclosed time and attendance system. Organization network 201 may include several time clock apparatus 101s positioned throughout the organization's facilities. These time clock apparatus 101s are connected, either through an Ethernet connection or wirelessly as described above, to an organization central server 250 where all time and attendance system information is stored. Authorized users then have access to the behind the clock software system through a behind the clock workstation 270. There may be several behind the clock workstation 270s positioned throughout the organization's facilities. The behind the clock workstation 270s may be PCs connected through organization network 201 to organization central server 250 as is known in the art.

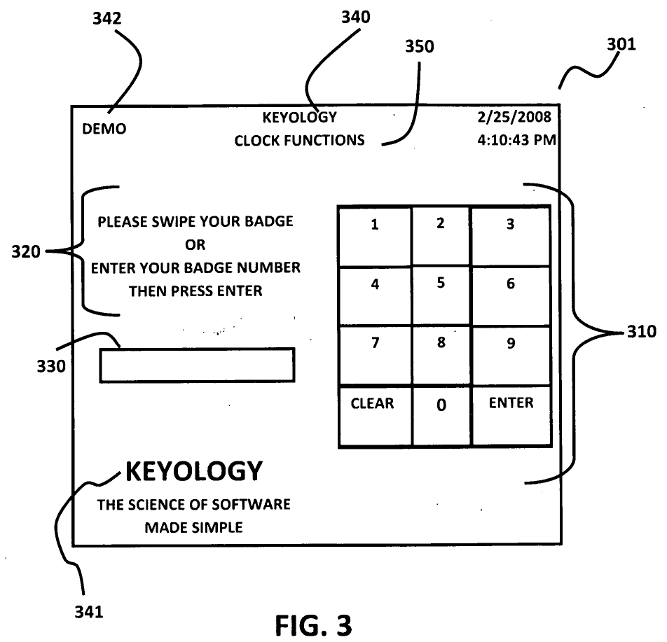

FIG. 3 illustrates the initial screen that an employee would encounter on employee display screen 110 upon walking up to the time clock. This initial screen may be referred to as default employee screen 301. Clock name 342, located in the upper left corner of default employee screen 301, may be used to label, or name, the clock within the overall time and attendance system. For example, a time clock located in a kitchen for use by kitchen staff may be labeled “Kitchen” at clock name 342, while another time clock located in a maintenance shed may be labeled “Maintenance” at clock name 342. Corporation name 340, located in the upper middle of default employee screen 301, may be used across each and every time clock to display a name of the corporation, company, or firm who licensed to operate the time and attendance system. Corporation name 340 is adjustable in the behind the clock software by authorized users.

Screen name 350, located just below corporation name 340 in the upper middle of default employee screen 301, may be used to label the set of currently available options facing the employee user at the present time. For example, as illustrated in FIG. 3, screen name 350 displays “Clock Functions” when an employee user initially encounters the time clock, and later may display “Clock Transaction” when the employee user is able to complete certain clock transactions, as will be described in detail below. Corporation logo 341, located in the lower left of default employee screen 301, allows the owner and operator of the time and attendance system to display their corporate logo, and is adjustable in the behind the clock software by authorized users.

User keypad 310, located on the right side of default employee screen 301, is a virtual keypad as is known by those skilled in the art. User keypad 310 allows an employee user to input numbered characters to represent the employee's badge number in appropriate situations, or any other number the employee wishes to manually input. In addition to virtual numbered buttons, or keys, at 310, user keypad 310 may also have a “CLEAR” button and an “ENTER” button, for use in clearing previously entered numbers or submitting previously entered numbers, as is known in the art.

User instructions 320, located to the left of user keypad 310, displays written messages to the employee user. User instructions 320 may be adjustable by authorized users within the behind the clock software. Entry field 330, located below user instructions 320, serves to display numbers either manually input by employee users at user keypad 310 or input by swiping the employee's badge through card swipe 120.

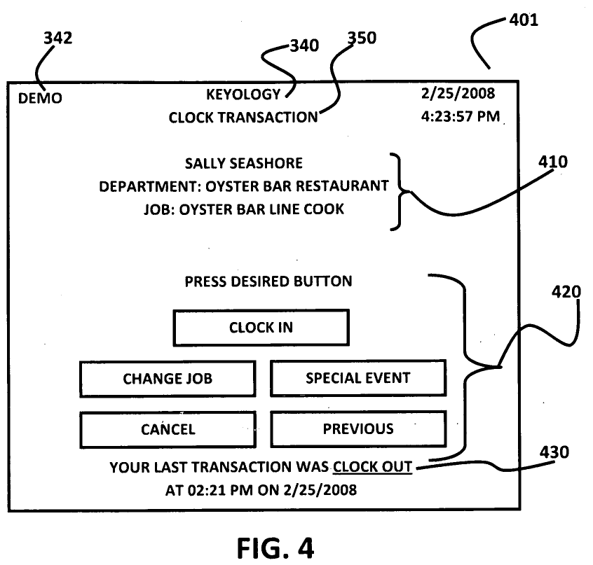

FIG. 4 illustrates the screen an employee user would see on employee display screen 110 on time clock apparatus 101 once the employee user has either: swiped his or her badge, keyed in his or her employee identification number at keypad 310, or swiped his or her finger/thumb for biometric identification. FIG. 4 illustrates employee clock in screen 401, which will appear when the employee user is not currently clocked in. The phrase “Clock Transaction” may be displayed at screen name 350. Employee information 410 displays information identifying the employee user, and may include such data as: the employee user's full name, the employee user's department within the overall organization, and/or the employee user's job title. The information displayed at 410 corresponds to that employee user's primary job, as opposed to a Special Event job that the employee user may work some times. The time and attendance system can be configured so that when employees clock in they are automatically assigned to their primary, or normal, job, at which point they may choose to change to another job, such as a special event job if they are authorized to work a special event or another alternative job.

Clock transaction buttons 420 may change according to how the employee user's authorization is set at the behind the clock software system. FIG. 4 shows at 420 a.“Clock In” button which the employee user may select to clock in to the time and attendance system; a “Change Job” button which the employee user may select to change his or her job title before clocking in; and a “Special Event” button which the employee user may select to allow selection of various Special Event options (as will be explained in greater detail below). Clock transaction buttons 420 also include both a “Cancel” button, which will cancel the current transaction, and a “Previous” button, which will bring the employee user back to the previously viewed screen, both of which may not be adjustable at the behind the clock software system and so will always be within clock transaction buttons 420. Last transaction 430 displays a message to the employee user showing the last recorded transaction for that employee user.

As stated, several of the clock transaction buttons 420 are adjustable by authorized behind the clock software system users. For example, an organization may not want certain types of employee to be authorized to change their own job title at clock in. In this case, an authorized behind the clock system user would alter the authorization level of those certain employees so that they cannot change their job—making the “Change Job” button unavailable at 420. Alternatively, even more options may be made available to an employee user at clock in screen 401. For example, “On Break” or “Off Break” buttons may be made available to employee users at 420, allowing them to record breaks without having to fully clock out. “On Property” or “Off Property” buttons may be made available to employee users at 420, allowing them to record whether they are working on or off property, also without having to fully clock out.

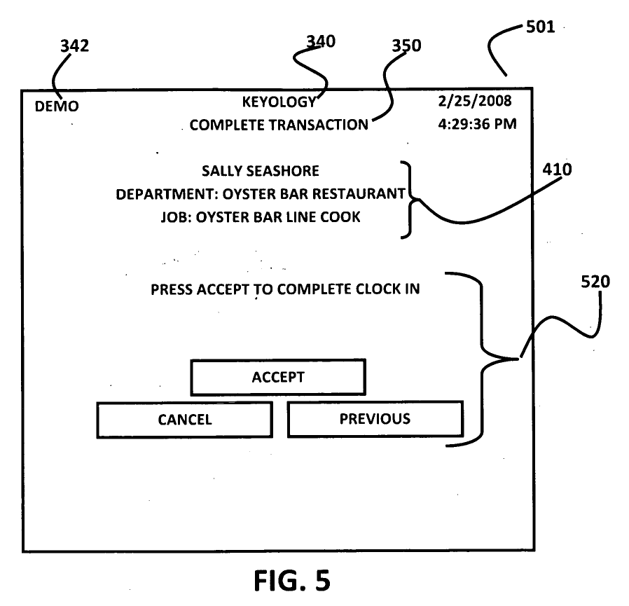

FIG. 5 illustrates a complete transaction screen 501. This screen, labeled “Complete Transaction” at screen name 350, allows an employee user to confirm his or her clock in. Complete transaction buttons 520 may include an “Accept” button which the employee user may select to confirm the clock in that he or she previously requested at the clock transaction screen 401 illustrated in FIG. 4. Once the employee user has selected the “Accept” button at 520, the clock in transaction is recorded on the organization central server and stored for future reference as needed.

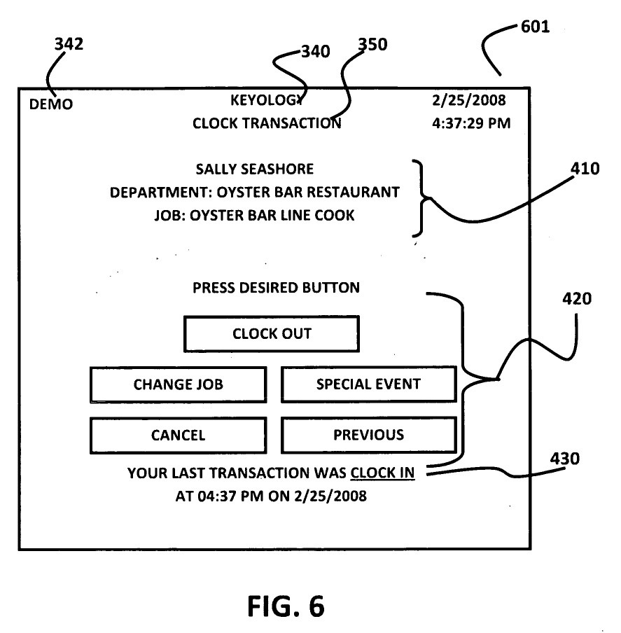

FIG. 6 illustrates an example clock transaction screen that an employee user may encounter when the employee user is currently clocked in. The primary purpose of clock out screen 601 is to allow the employee user to clock out once he or she is done with work for the day. Clock out screen 601 functions in the same general manner as clock in screen 401 illustrated in FIG. 4. The difference is that if the employee user is currently clocked in to the time and attendance system, then the employee user will see a “Clock Out” button at 420 instead of a “Clock In” button at 420. Last transaction 430 should imply to the employee user that he or she is currently clocked in by showing that the last transaction was a clock in, as can be seen in FIG. 6 at 430.

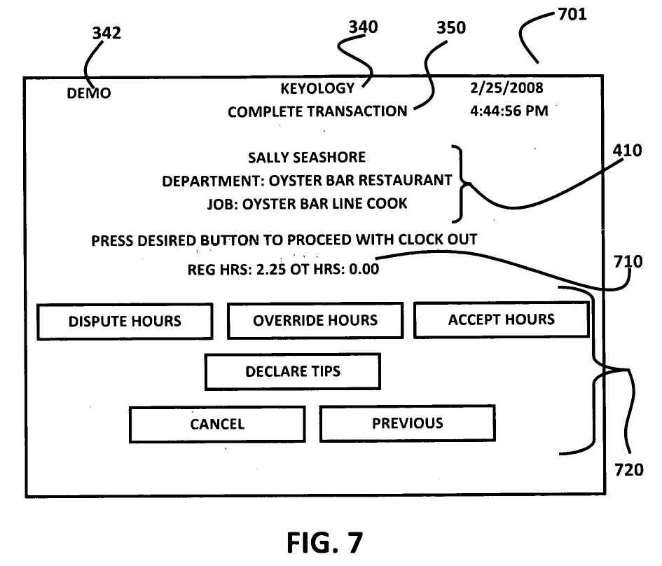

FIG. 7 illustrates an example of a screen the employee user may encounter after selecting the “Clock Out” button on clock out screen 601 (illustrated in FIG. 6). Clock out options screen 701 includes employee information 410, and hours clocked 710. Hours clocked 710 shows the employee user how many hours he or she has been credited with working. As seen at 710, the time and attendance system may individually show regular hours worked (“Reg Hrs:” in FIG. 7) and overtime hours worked (“OT Hrs:” in FIG. 7). These hours may be displayed in either decimal format by hour, as seen in the figure, or in hours and minutes format. If the organization chooses to display hours worked in decimal format, the mathematical rounding necessary to convert minutes into decimal fractions of an hour is carried out at the organizational central server. Rules for rounding can be adjusted by authorized users at the behind the clock system.

The employee may proceed at clock out options screen 701 by selecting one of the options at clock out complete transactions buttons 720. When the employee clocks out, the time and attendance system can be configured to automatically calculate the number of hours worked by the employee, including whether those hours were regular hours, overtime hours, or some other type of hours, such as double time, make up time or many other types of hours. An hours worked message will then be sent from the central server to the time clock apparatus being used by the employee. After viewing the hours worked message, the employee user may choose to accept the hours displayed at 710 by selecting the “Accept Hours” button at 720. Once the employee user selects the “Accept Hours” button, the time and attendance system creates a record in the accompanying/integrated human resources software and stores a record of the transaction at the organization central server 250. The employee user may have additional options at clock out options screen 701, such as the ability to declare tips received during the current work shift (“Declare Tips” button at 720), or view and dispute or override the hours displayed at 710 if the employee believes the displayed hours to be incorrect.

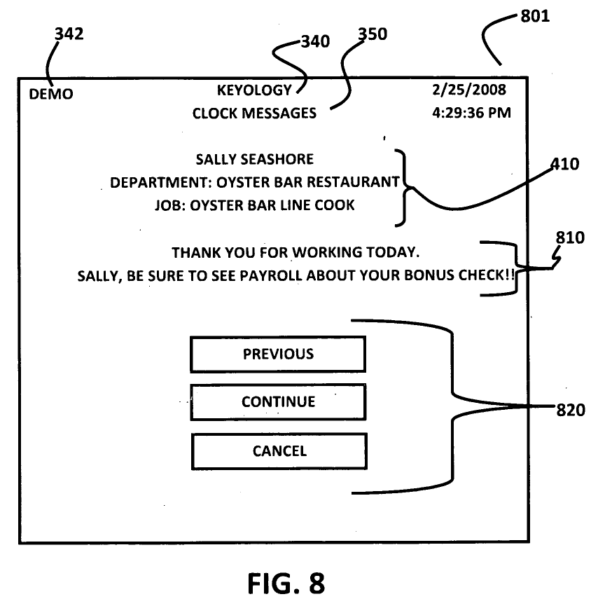

FIG. 8 illustrates a clock messages screen 801. With the time and attendance system, the organization has an ability to display customized messages to any employee who clocks in or out at one of the time and attendance system time clock apparatuses. An exemplary embodiment of the time and attendance system allows clock messages (text-based messages from the organization, or from management, directed to employees) to be displayed to employee users of the time clock apparatus at the time of clocking in or clocking out, or during other times, such as during job changes.

Clock message 810 is located in the middle of clock messages screen 801, just below employee information 410 and just above clock message options buttons 820. The message displayed at 810 is fully adjustable at the behind the clock system by authorized users, and may be automatically translated into various available languages. Additionally, it may be possible to display lengthy clock messages at 810, even clock messages that span several pages of text. In that case, additional buttons may be available to the employee user at 820, such as a “Page Down” and/or “Page Up” button, which would allow the employee user to scroll up and down through multiple pages of text, as is known in the art.

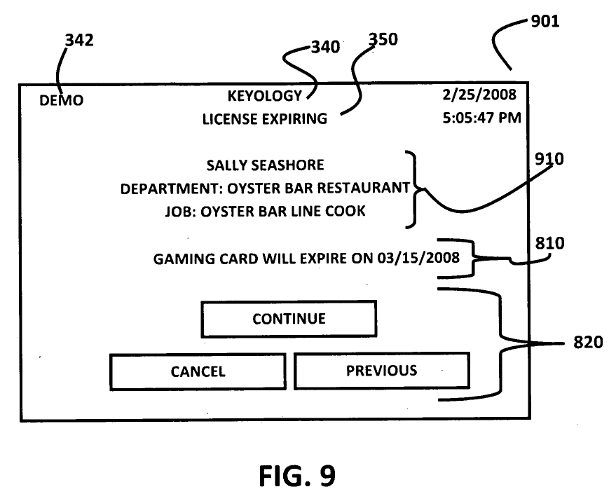

FIG. 9 illustrates a particular type of clock message: a license or requirement expiring message. Gaming employees are often required to renew their licenses with gaming control boards or similar regulatory agencies, and this message is used to remind them of this fact, but it could also be used to track many other aspects of an employee's employment or life. For example, employees could be reminded to get health screenings or perform other activities. It could even be used to wish them happy birthday or to commemorate their work anniversary with their employer. When tracking gaming licenses, at the behind the clock system, information such as issue date, expiration date, etc., may be input and then tracked so that employee may be timely notified of any potential licensing issues. These expiration notices are much like clock messages and may be displayed during an employee user's attempted clock in or clock out. In the example shown in FIG. 9, Sally Seashore is being alerted on February 25 to the fact that her gaming card will expire on March 15. If an employee user's license is actually expired, as opposed to expiring soon, then the time and attendance system can be configured to treat this as an event that requires a Supervisor Override or authorization (as described below) before the employee user is able to continue with his or her clock in.

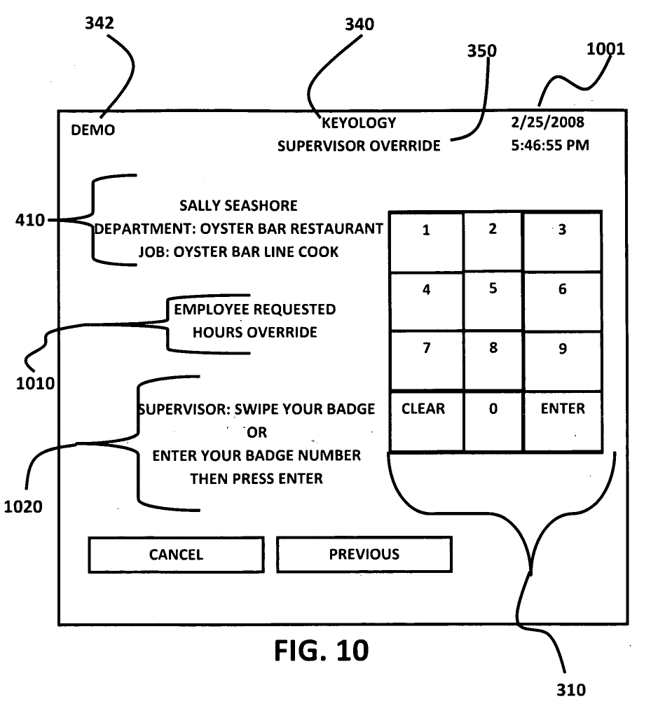

FIG. 10 illustrates both an override message and a request from the time and attendance system for a Supervisor Override. When an employee user either attempts to perform a function that he/she is not authorized to perform (change jobs, for example) or attempts to perform a function that requires a Supervisor Override (hours override, for example), screen name 350 will automatically change to display “Supervisor Override”, and override message 1010 will display the reason for the override, such as “Employee requested Hours Override” as seen in FIG. 10. Supervisor instructions 1020 display a message instructing the Supervisor to either swipe his or her badge or to manually enter his or her badge number. At the time the Supervisor swipes their badge or enters their identification, the time and attendance system will also check the authorization level required for the override or authorization requested. If the Supervisor has a sufficient authorization level, then the Supervisor will be allowed to continue by either authorizing the transaction or rejecting the transaction, otherwise a message may be displayed indicating that a higher level authorization is required.

The following employee user functions or events may trigger a request for Supervisor Override under certain conditions set by authorized users at the behind the clock system: employee user is not authorized to that particular time clock apparatus; employee user entered his or her badge number manually on keypad 310; employee user has an expired license (unless the behind the clock system has been configured to totally prohibit employee users with expired licenses from clocking in, in which case no Supervisor Override would be triggered); employee user's manual badge entry limit as configured at behind the clock system has been exceeded; employee user has requested an unauthorized Special Event; employee user has requested an unauthorized change of jobs; employee has worked unauthorized overtime hours; and/or employee has requested an hours override.

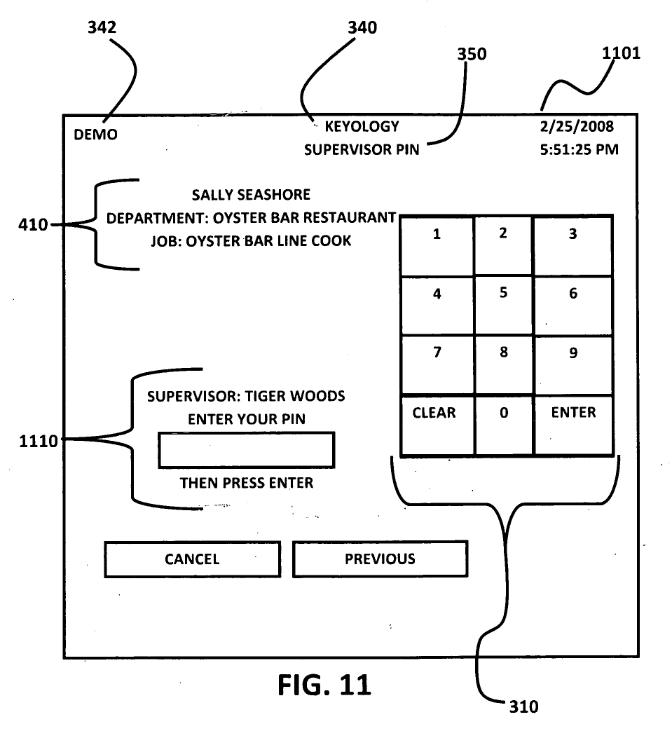

Once the supervisor has swiped his or her badge as instructed at 1020 on supervisor override screen 1001, the screen will change to supervisor PIN screen 1101, as illustrated in FIG. 11, and will display “Supervisor PIN” at screen name 350. Error message 1010 and supervisor instructions 1020 of FIG. 10 are replaced by supervisor PIN instructions 1110 of FIG. 11, which ask that the supervisor enter his or her PIN number on input keypad 310 to confirm that this supervisor is in fact authorizing the previously unauthorized employee user request or function. For security purposes, the numbers entered by the supervisor on keypad 310 are not visibly displayed, but are rather displayed as a series of asterisks (“****”) or some other indecipherable form at 1110, so that those persons within view cannot see the supervisor's PIN number, as is known in the art.

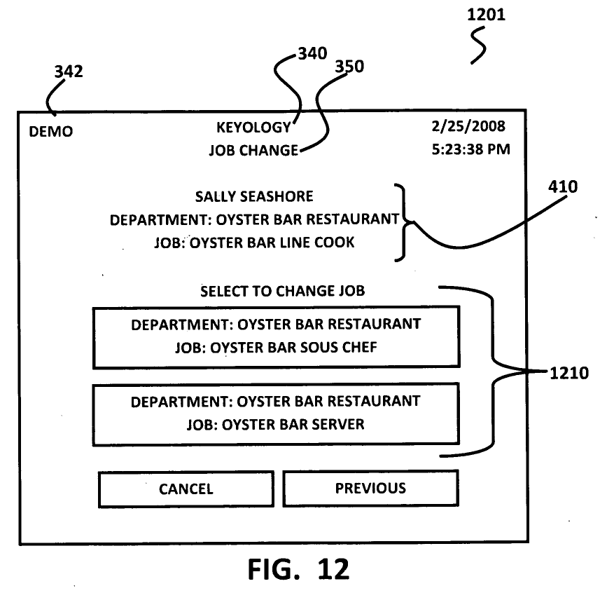

FIG. 12 illustrates Job Change screen 1201, which an employee user would encounter after selecting the “Change Job” button at 420 on clock transaction screen 401 of FIG. 4. This would occur when the employee is attempting to clock in to the time and attendance system. Screen name 350 may display “Job Change”, and job change options 1210 may display the various jobs from which the employee user can choose. In FIG. 12, for example, two jobs are listed at 1210. The jobs listed at 1210 depend on the badge number of the employee user and what authorized jobs have been assigned to that badge number at the behind the clock system. If more than two jobs are available to a particular employee user, and therefore more than two jobs must be displayed at job change options 1210, then additional buttons, such as “Page Up” and “Page Down” may be available to the employee user to scroll through multiple screens of job options.

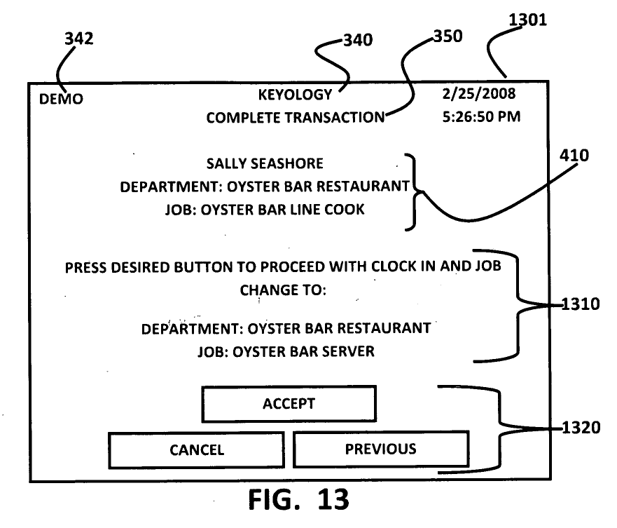

Once the employee user has made his or her selection at job change options 1210 on job change screen 1201, the screen changes to complete transaction screen 1301, as is illustrated in FIG. 13. At complete transaction screen 1301, the employee user is shown a description of the new job (new job title and the corresponding department, for example) at 1310 and asked to either accept the change arid clock in, cancel the change, or move back to the previously viewed screen at 1320. If the employee user chooses to accept the job change, he or she will be clocked in to the time and attendance system under the newly designated job title within the newly listed department within the overall organization.

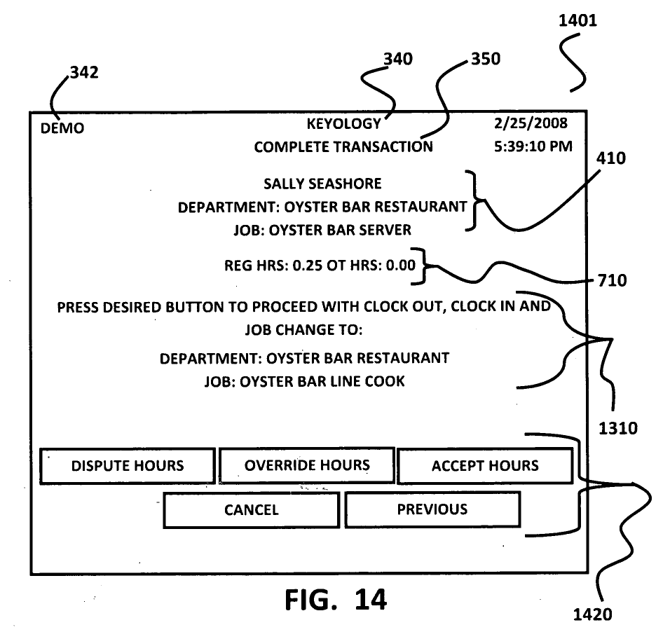

It is also possible to allow job changes mid-shift. If such ability is desired, authorized employees who are currently clocked in to the time and attendance system will be able to walk up to a time clock apparatus, swipe in, and then simultaneously clock out from the current job, change jobs, and then clock in to the new job. When an employee performs a job change transaction, after having previously clocked in, the time and attendance system could also clock the employee out of their current job and clock them into the new job automatically, so the employee only has to enter the job change. A job change situation is illustrated in FIG. 14. At the time of the desired mid-shift job change (a job change requested while the employee user is currently clocked in), hours clocked 710 displays the hours accumulated during the current shift up until the time the job change was requested. The employee user's new job is again described at 1310.

In this situation, the employee user has more options at 1420. He or she may be able to accept the listed hours, at which point the employee user is simultaneously clocked out of the previous job, a record is sent and stored at organization central server 250, and clocked into the new job. The employee user may also be able to select a “Dispute Hours” button or an “Override Hours” button at 1420. If the employee user selects a “Dispute Hours” button, the record of the hours clocked for that shift will be flagged within the time and attendance system at the organization central server, but no edits will be made to the record at the time clock apparatus. Once the record is flagged (an event requiring supervisor authorization), that record will not be sent to payroll until it is approved by a manager or supervisor. The employee user is simultaneously clocked out.

It should be noted that within the behind the clock system, authorization to change jobs can be granted or denied to individual employees, to entire departments, or to specific time clock apparatuses. For example, the behind the clock system can be configured so that a particular employee can change jobs at a centrally located time clock apparatus, but cannot change jobs at a remotely located time clock apparatus. Or, in another example, the same employee can change jobs on his or her own at the centrally located time clock apparatus, but needs to obtain a Supervisor Override to change jobs at the remotely located time clock apparatus.

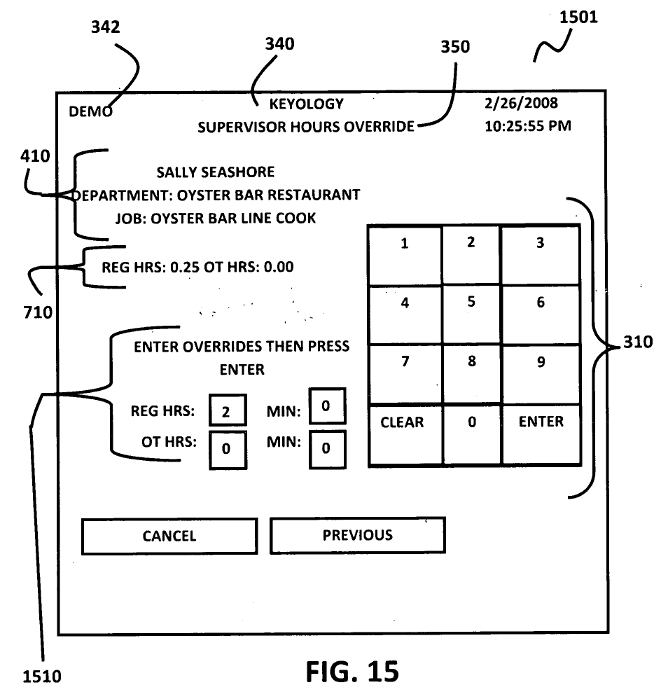

If an employee has chosen to override hours listed at hours clocked 710, by selecting an “Override Hours” button, a supervisor will be asked to perform a Supervisor Override as described above. After inputting his or her PIN number as illustrated in FIG. 11, the time clock apparatus employee display screen will switch to supervisor hours override screen 1501 as illustrated in FIG. 15. At supervisor hours override screen 1501, the supervisor must manually enter the correct hours using input keypad 310. This may be done by first manually entering the correct regular hours using keypad 310, then pressing the “ENTER” button within keypad 310. The correct regular hours will then be displayed at 1510. Next, the supervisor enters the correct regular minutes using keypad 310, then presses the “ENTER” button, and the correct regular minutes will be displayed at 1510. Then the supervisor enters the correct overtime hours using keypad 310 and presses “ENTER”, and the correct overtime hours will be displayed at 1510. Finally, the supervisor enters the correct overtime minutes using keypad 310 and presses “ENTER”, and the correct overtime minutes will be displayed at 1510.

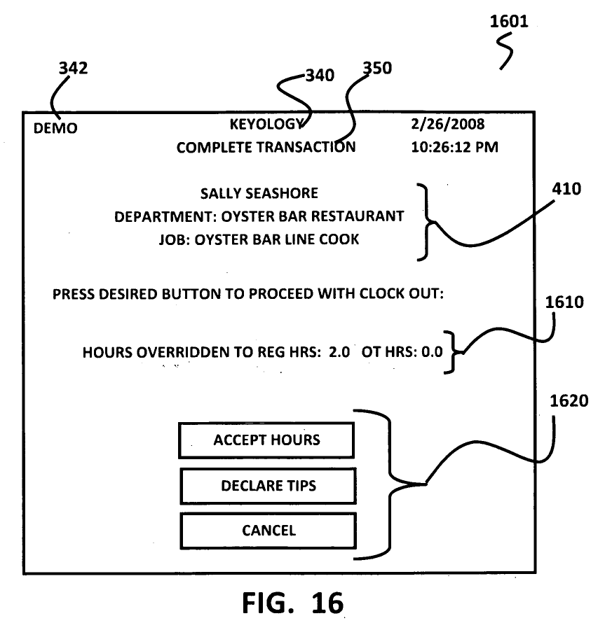

Once overtime minutes have been manually entered by the supervisor, the time clock apparatus employee display screen will advance to override complete transaction screen 1601 as illustrated in FIG. 16. At override complete transaction screen 1601, the supervisor may view the corrected hours for the employee at hours overridden 1610, and then may choose to accept the hours overridden by selecting “Accept Hours” at 1620. If the hours overridden 1610 are accepted, the employee user is clocked out from the time and attendance system and a record of the transaction is sent to the organization central server.

When an employee user is clocking in, as illustrated in FIG. 4, or clocking out, as illustrated in FIG. 6, the employee may be authorized (depending on authorization set at the behind the clock system) to clock in to a special event. A special event is a one time, or limited time, job that a regular employee can work. Special events must be pre-designated at the behind the clock system before an employee user can select, and clock in, to a special event. For example, an organization may be hosting a large business conference that includes a catered dinner. The organization can designate the dinner as a special event at the behind the clock system and designate certain employees, or certain types or departments of employees, as being authorized to work the dinner. Then, those authorized employees can clock in and out of the special event and have their hours recorded as special event hours, which may pay more or be counted differently than the employees' regular job, for example.

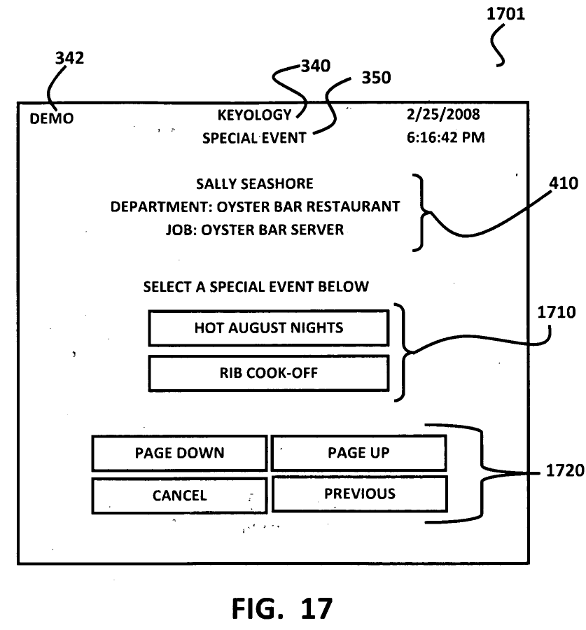

If an employee user selects a “Special Event” button at 420 on clock in screen 401, or selects a “Special Event” button at 420 on clock out screen 601, the screen will advance to special event screen 1701 as illustrated in FIG. 17. The employee user will then be able to view all pre-designated special events at special events list 1710. If many special events are pre-designated for the employee user, the employee user may be able to scroll up and down the special events list 1710 by selecting either a “Page Up” button at 1720 or a “Page Down” button at 1720, as is known in the art. The employee user then selects a special event from special events list 1710. The behind the clock system may additionally be configured so that an employee (or types of employees or departments of employees) can view all special events in special events list 1710, but the employee cannot clock in to one or more of the special events without a supervisor override. In such a situation, the supervisor override functions much like described above: a supervisor must swipe in, enter a PIN number, and approve of the special events clock in.

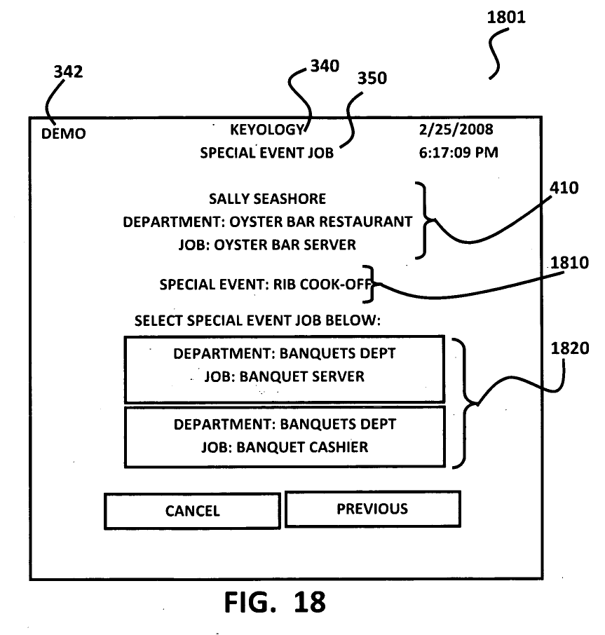

In addition to merely selecting a special event, the time and attendance system can designate and track multiple specific special event jobs for each special event. If multiple special event jobs are pre-designated for a special event at the behind the clock system, then after selecting a special event at special events screen 1701, the screen will advance to special events jobs screen 1801 as illustrated in FIG. 18. The special event the employee user has previously selected is displayed at 1810, and a listing of the corresponding available special event jobs is displayed at special event jobs list 1820. The employee user then selects one of the special event jobs listed at special event jobs list 1820. If more than two special event jobs are available, then it may be necessary to provide a “Page Up” and a “Page Down” button to allow the employee user to scroll through the complete list of special event jobs, as is known in the art.

An employee currently clocked in to a regular job can switch to a special events job mid-shift. To do this, the employee user would swipe into the time clock apparatus as described above, and the screen would advance to clock out screen 601 as described above. The employee user would then proceed to select a special event and a special event job as described. Then the screen would advance to a screen that displays hours currently accumulated for the regular job, and the employee user would have an opportunity to accept the displayed hours, dispute the displayed hours, or request a supervisor override of the displayed hours. Once the employee user makes this selection, he or she is clocked out of the regular job and immediately clocked into the special events job previously selected.

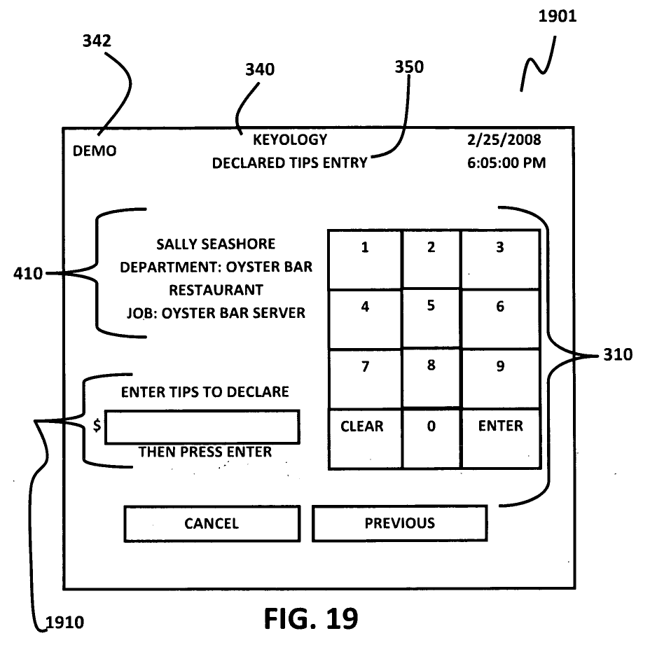

As previously noted, an organization is also able to allow an employee to declare tips and have those tips recorded and tracked through the time and attendance system. At clock out confirmation, as illustrated in FIG. 7, an employee user is additionally able to select a “Declare Tips” button at 720. When this button is selected, the screen will advance to a declared tips entry screen 1901 as illustrated in FIG. 19. At declared tips entry screen 1901, the employee user may enter a tips amount using the input keypad 310. The tips amount may be entered using dollars only, in which case the employee user should round all tips to the nearest dollar and enter that amount, or tips amount may be entered using both dollars and cents, in which case the employee user should enter both full dollars and decimal fractions of dollars (i.e. cents) received as tips. Tips amount entered via keypad 310 may be displayed at tips entry field 1910. If tips have already previously been entered by that employee user during the same shift, that tips amount may be displayed on declared tips entry screen 1901.

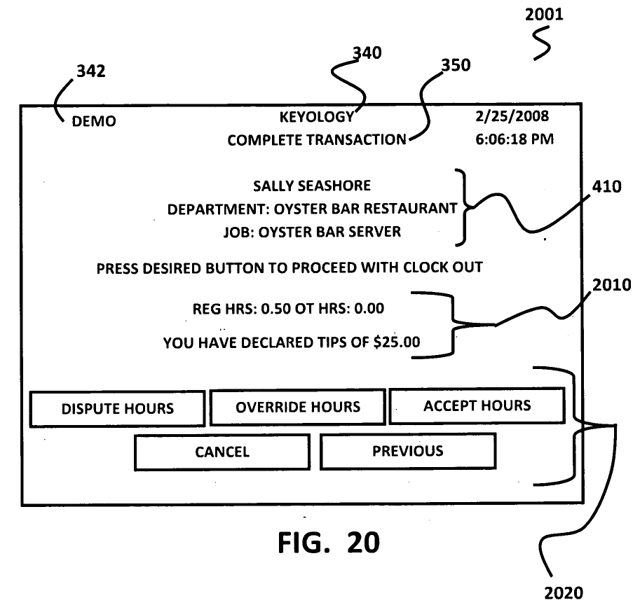

The organization may configure the behind the clock system to allow only up to a pre-determined maximum tips amount for an employee (or a particular type of employee or a particular department of employees). If the tips amount entered by an employee user is greater than the pre-determined maximum tips amount for that employee, an error message may be presented on screen to the employee user or a Supervisor Override may occur. In the event of an error message, the employee user must select the “CLEAR” button on keypad 310 to delete the previously entered tips amount and re-enter a lower tips amount, again using keypad 310. Once an acceptable tips amount is entered, the screen will advance to a tips declared complete transaction screen 2001, as illustrated in FIG. 20. In addition to hours clocked, tips declared complete transaction screen 2001 displays the tips amount to the employee user at 2010. At this time the employee user may then choose to dispute the hours, request a supervisor override, or accept the hours by selecting from the buttons 2020, as described previously for other clock outs.

The time and attendance system additionally has the ability to record and track employee breaks during clocked in time. This feature (on/off break) is only appropriate for already clocked in employees. For example, if an employee is clocked in as a cook in the organization's kitchen, that employee may be able to swipe his or her badge at the time clock apparatus, and then select an “On Break” button to begin a smoke break for example, then return, swipe the badge again, and select “Off Break” to end the break. The time and attendance system would then have a record of the employees break and would be able to handle that break time as configured at the behind the clock system. For example, the organization could choose to only record break time for internal review purposes without deducting that break time from employees clocked in time. Alternatively, the organization could choose to deduct recorded break time from employees clocked in time, or pay a lower wage during break time. The break time option may be available to a clocked in employee user at clock out screen 601, similar to that screen illustrated in FIG. 6. If the option is configured at the behind the clock system, an “On Break” button would be visible to the employee user at clock out buttons 420. The employee user would select such a button to record being on break. If previously on break, the same screen would instead display the opposite corresponding button: “Off Break”.

A related feature is an ability to track whether employees are “on property”, meaning whether the employee is on the organization premises, whether or not the employee has yet clocked in or already clocked out. The time and attendance system can track, in this way, both salaried employees who are not required to clock in and clock out and hourly employees who must clock in and clock out. For example, a time clock apparatus configured for on-property/off-property log-ins can be located at a main employee entrance way. Employees, both salary and hourly, can be instructed to log-in, or swipe in, as being “on-property” as soon as they enter the organization's building or property. For salary employees this would be the extent of their time clock transactions until they leave the building, at which time they swipe out as being “off-property”. For hourly employees, they would proceed to prepare for their shift (eat breakfast, change into uniforms, wash-up, etc.) and then clock in at a time clock apparatus (possibly a different time clock apparatus located elsewhere) when they begin their shift. The hourly employee would then be able to clock out after his or her shift without swiping out as being “off-property”. Tracking “on-property” and “off-property” in this way allows the organization's management to query the storage system to quickly determine, at behind the clock, which employees are currently on-property in case of an emergency such as a fire.

If at any point in an employee user's use of the time clock apparatus the employee user attempts to initiate a function that he or she is not authorized to make (either on purpose or by mistake), the time and attendance system may notify the employee user of the mistake by indicating the error in a text box on the screen. The text box may be red or an alternatively distinctive color so as to stand out from the screen and be readily apparent to the employee user. For example, if an employee user attempts to swipe his or her badge at card swipe 120, or manually enter his or her badge number at keypad 310, the employee user may receive an error message for one or more of the following reasons: the badge number is invalid (meaning that the badge number has not been recorded or assigned on the behind the clock system); the employee user is not active (meaning that a manager, or another authorized user, has made that employee user inactive at the behind the clock system and therefore that employee user is not authorized to clock in or clock out); the employee user is not authorized to that particular time clock apparatus (meaning that the behind the clock system has restricted that employee user, or that type of employee user, to only being able to utilize particular time clock apparatuses within the overall organization's time and attendance system comprising several time clock apparatuses); the employee user cannot perform that particular requested function (for example, attempting to perform a Supervisor Override when the employee user is not an authorized Supervisor or is not authorized to perform Supervisor Overrides); invalid PIN number (certain features may be adjustable so that the user must input a PIN number); or the employee user is not required to clock in (as would be the case for a salaried employee).

After receiving an error message, the employee user can then: attempt the desired transaction again (which may be effective if the employee user simply made a typing mistake); attempt to get a Supervisor Override by his or her Supervisor if the error is related to authorization level of the employee user; or attempt an alternate transaction.

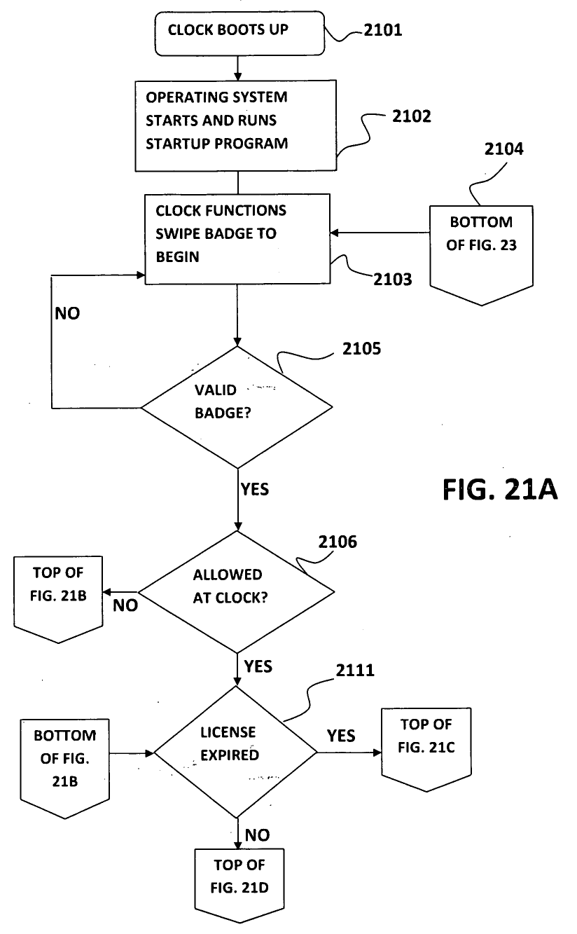

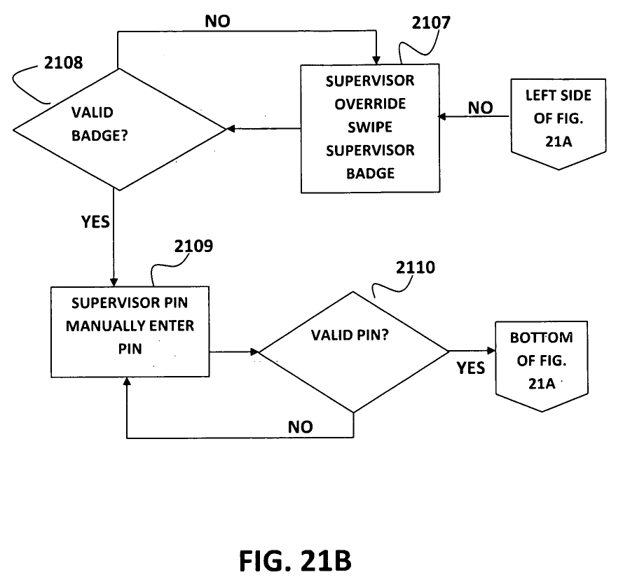

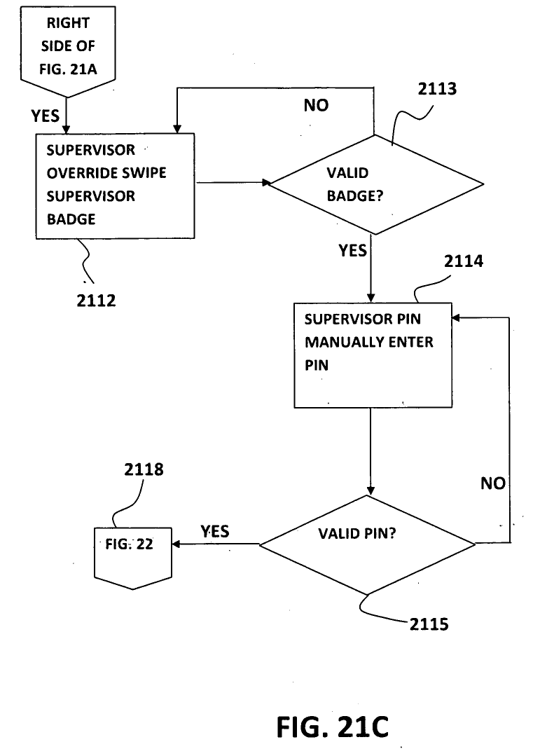

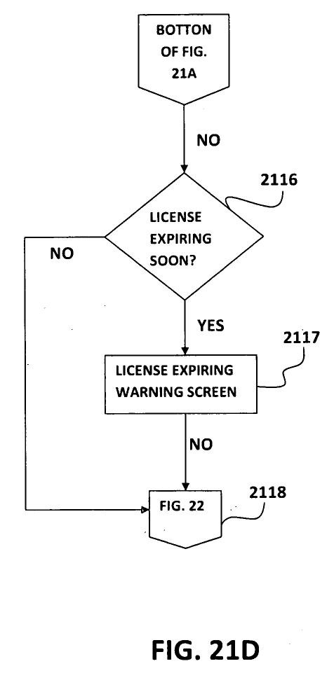

FIGS. 21A through 23B illustrate a flow chart of a time clock apparatus of the time and attendance system. As previously noted, the overall system would operate within a computer network environment, as is well known in the art, a main portion of the system residing and operating on central server 250 of FIG. 2, with other components running on each of the time clocks 101. The time clock apparatus initially boots up at 2101 and the operating system (either within the central server 250, or the time clock 101, or both) runs a startup program at 2102. The screen then displays default employee screen 301 at 2103, which may be labeled “Clock Functions” at screen name 350 as illustrated in FIG. 3, and a user is asked to swipe his or her badge to begin. The swipe badge screen will also be displayed as a result of other steps 2104 in the process, as further described below. If the badge is valid at 2105 the user may continue; if the badge is invalid at 2105 the system remains on default employee screen 301 at 2103.

The system next checks at 2106 whether the employee user who swiped the badge is allowed at that particular time clock apparatus. If not, the system asks for a supervisor override at 2107 in FIG. 21B, as illustrated at supervisor override screen 1001 at FIG. 10. A supervisor is asked to swipe his or her badge at 2107 and the badge is checked at 2108. If the supervisor badge is not valid, the system remains at supervisor override screen 1001 at 2107. If the supervisor badge is valid, the system advances to supervisor PIN screen 1101 as illustrated in FIG. 11 and asks that the supervisor enter his or her PIN number, at 2109. This PIN number is checked by the system at 2110: if the PIN is invalid the system remains at supervisor PIN screen 1101, reverting to 2109 in FIG. 21B; if the PIN is valid the system advances to 2111.

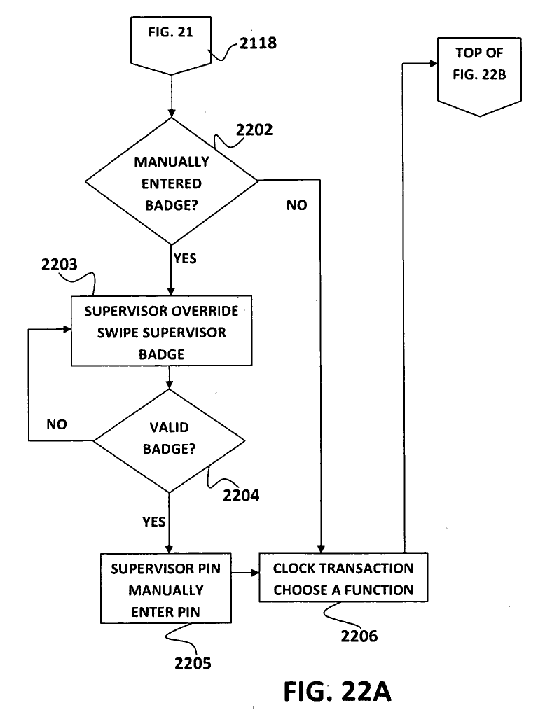

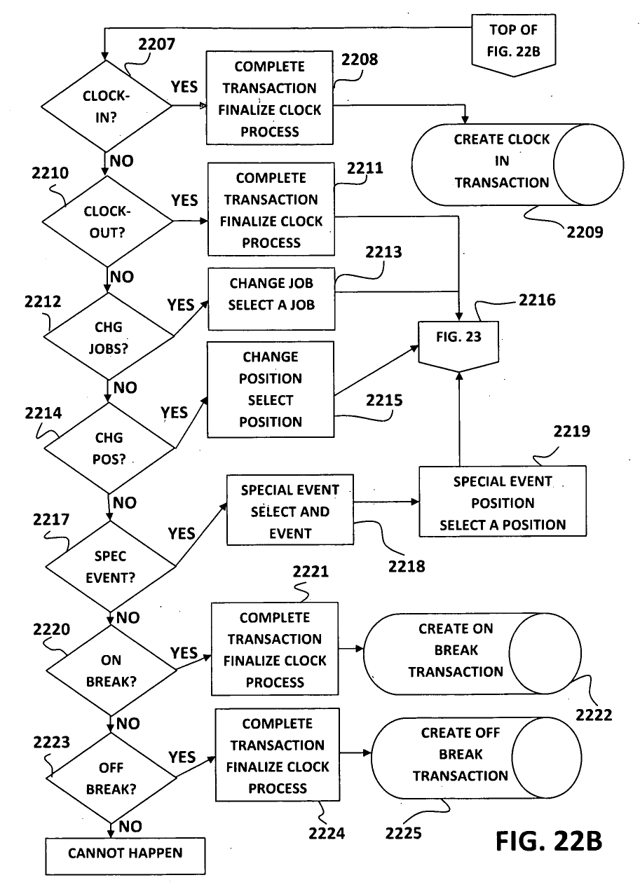

If the employee user who swiped the badge is allowed at that particular time clock apparatus, as checked at 2106, then the system advances directly to 2111. At 2111 the system checks whether the employee user has an expired license. If the employee user's license is expired, the system will request a supervisor override at 2112 as illustrated in FIG. 21C. Similarly to other supervisor overrides, the supervisor will be asked to swipe his or her badge at 2112, the badge will be checked for validity at 2113, the supervisor will be asked to enter his or her PIN number at 2114, and the PIN will be checked for validity at 2115. If the employee user's license is expired but the employee user obtains a valid supervisor override (including valid supervisor badge and PIN), then the system will advance to 2118, which continues onto FIG. 22A.

If the employee user's license checks out as not expired at 2111, then the system will check whether the employee user's license will expire soon at 2116 as illustrated in FIG. 21D. If the license will expire soon, (“soon” is obviously a relative concept—how soon is enough to trigger a warning, which may be referred to as an expiring soon time period, can be configured by authorized users at the behind the clock system) the system advances to a 2117, where the employee user is shown a clock messages screen 801, as illustrated in FIG. 8, displaying a message at clock message 810 to the employee user indicating that the license will soon expire (FIG. 9 illustrates this type of a clock message). The system then advances to 2118, which continues on to FIG. 22A. If the employee user's license is determined not to be expiring soon, then the system advances directly to 2118 as illustrated in FIG. 22A.

FIGS. 22A and 22B are flowcharts further illustrating the time clock apparatus of the time and attendance system. After advancing through the badge validity check, the allowed at clock check, the license expired check, and the license expiring soon check described and illustrated in FIGS. 21A, 21B, 21C, and 21D, the system checks at 2202 whether the employee's badge number was previously entered by swiping or by manual input via keypad 310. If entered by swiping, thus not entered manually, the system advances to 2206: a screen labeled “Clock Transaction” at screen name 350, which may be similar to clock in screen 401 illustrated in FIG. 4. If the badge number was entered manually, the system may be configured (depending on choices made at the behind the clock system) to then request a supervisor override as previously described. A supervisor will be asked to swipe his or her badge at 2203 and the system will check for a valid supervisor badge number at 2204. If the badge number is valid, the system will request that the supervisor enter a PIN number at 2205, and if this PIN is valid, the system advances at 2206 to the screen labeled “Clock Transaction” at screen name 350, which may be similar to clock in screen 401 illustrated in FIG. 4.

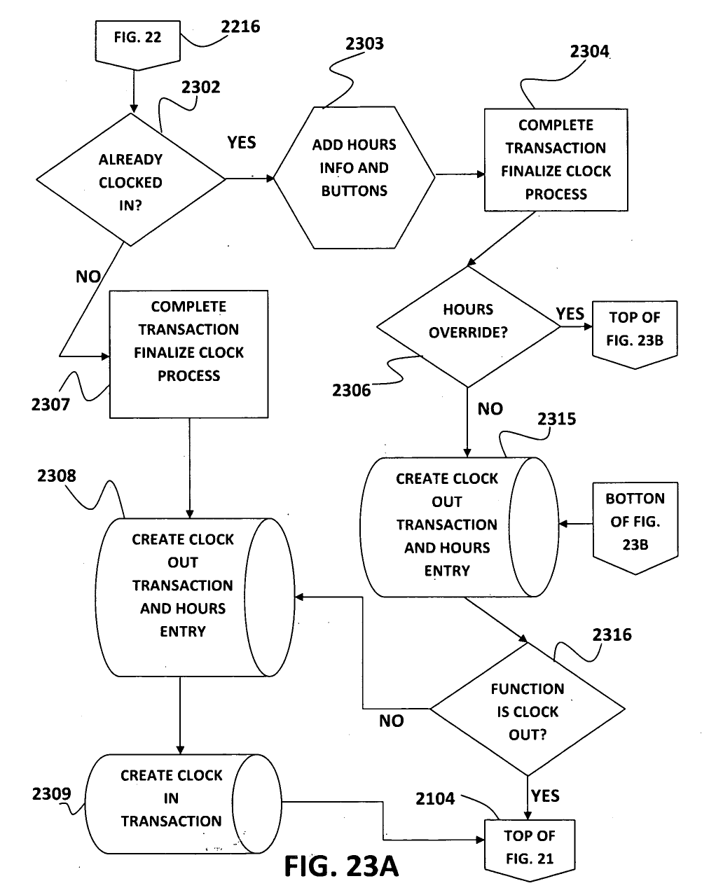

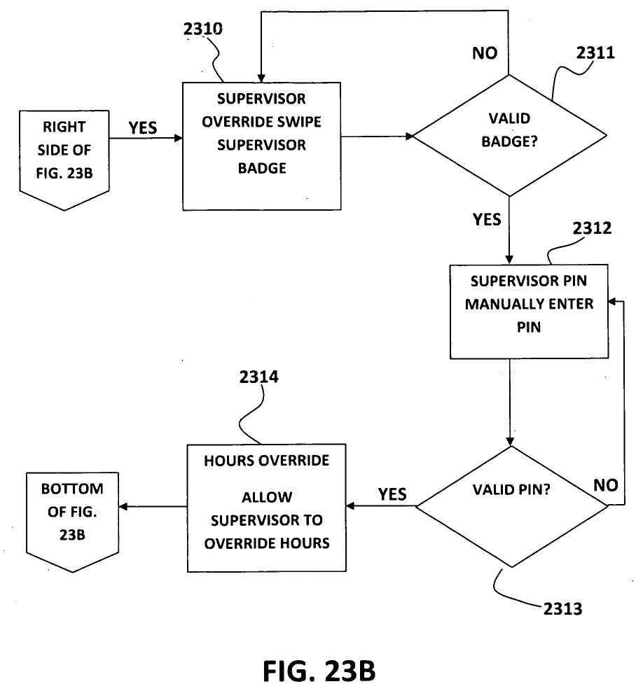

When the system is at clock transaction 2206, an employee user will have a choice of several actions as illustrated in FIG. 22B. The employee user may choose to clock in at 2207, in which case a clock in occurs as described above in which the employee user may accept the clock in at 2208 and a record of the transaction is sent to the organization central server (see FIGS. 4 and 5 and the corresponding detailed description). If the employee user does not clock in at 2207, the employee user may choose to clock out at 2210. The system then asks for acceptance of the clock out at 2211, and then advances to 2216, which is explained in FIG. 23A and below. If the employee user does not clock in at 2207 and does not clock out at 2210, the employee may choose to change jobs at 2212. The system then asks for a selection from the employee user of a new job at 2213, and then advances to 2216, which is explained in FIG. 23A and below.

If the employee user does not clock in at 2207, does not clock out at 2210, does not change jobs at 2212, the employee user may choose to clock into a special event at 2217. The system then asks for a selection from the employee user of the special event from a list of special events at 2218, and asks for a selection from the employee user of the special event job from a list of special event jobs at 2219, and then advances to 2216, which is explained in FIG. 23A and below (see FIGS. 17 and 18 and the corresponding detailed description). If the employee user does not clock in at 2207, does not clock out at 2210, does not change jobs at 2212, and does not clock into a special event at 2217, the employee user may choose to be on break at 2220. The system requests acceptance that the employee user is going on break at 2221, and then a record of the on break transaction is created and sent to the organization central server at 2222. If the employee user does not clock in at 2207, does not clock out at 2210, does not change jobs at 2212, does not clock into a special event at 2217, and does not choose to be on break at 2220, the employee user may choose to be off break, or end his/her break, at 2223. The system will then request acceptance that the employee user is going off break at 2224, and then a record of the off break transaction is created and sent to the organization central server at 2225.

FIGS. 23A and 23B are flowcharts further illustrating the time clock apparatus of the time and attendance system. If the employee user has previously chosen to clock out at 2210, change jobs at 2212, or clock into a special event at 2217, the system will eventually advance to 2302 of FIG. 23A, where the system will check whether the employee user is already clocked in to the time and attendance system. If yes (employee user is currently clocked in), the hours clocked during the current shift is determined at 2303. The system then displays the clocked hours, along with options whether to accept those hours, dispute those hours, or override those hours at 2304 (see FIG. 7 and corresponding detailed description). The system determines whether an hours override was requested at 2306. If an hours override was requested by the employee user, the system will request a supervisor override as described above. The system asks the supervisor to swipe his or her badge at 2310 in FIG. 23B, checks whether the badge is valid at 2311, asks the supervisor to enter his or her PIN number at 2312, checks the validity of the PIN number at 2313, and then prompts the supervisor to manually enter, via keypad 310, alternate hours at 2314 (see FIGS. 10, 11, 15 and 16, and the corresponding detailed description). The system then creates, and sends to the organization central server, a clock out transaction and a record of the hours clocked at 2315 in FIG. 23A.

If at 2306 the system determines that an hours override was not requested by the employee user, the system will advance directly to 2315 in FIG. 23A to create, and send to the organization central server, a clock out transaction and a record of the hours clocked. Then, if the current transaction is determined at 2316 to be a clock out, the system will revert to the initial employee user screen at 2104 in FIG. 21A. If the current transaction is determined at 2316 not to be a clock out (instead it's either a job change, or a special event clock in) then a record of the current transaction is created at 2308 and sent to the organization central server, a new clock in (for the new job or special event) is established at 2309. Then the system will revert to the initial employee user screen at 2104 in FIG. 21A.

If at 2302 the system determines that the employee user was not previously clocked in to the time and attendance system, then the system requests an acceptance of the change (change of job or special event) at 2307 in FIG. 23A, creates and sends to the organization central server a record of the transaction at 2308, clocks in the employee at 2309, and finally reverts to the initial employee user screen at 2104 in FIG. 21A.

The behind the clock system portion of the time and attendance system will now be described. This behind the clock system may be referred to simply as behind the clock, or alternatively, as the back of the house system, or simply back of the house. The organization may authorize a select few individuals to be allowed to set-up and then maintain the behind the clock portion. These fully authorized employees may be given secret PIN numbers, or passwords, to maintain security, as is known in the art. Behind the clock may allow configuration of all or some of the following: maintain badge codes; maintain shifts; maintain reason codes (the time and attendance system may require a reason be stated, or chosen, for each manager alteration of an existing transaction record); maintain a holiday calendar; maintain language translations; view hours status codes; view transaction codes; maintain master control information; maintain menu security; etc. All available authorization levels, authorized functions, active holiday dates, and shifts can be individually configured for any employee corresponding to any permutation of company, division, department, pay type (hourly or salary), and employee status (part-time or full-time).

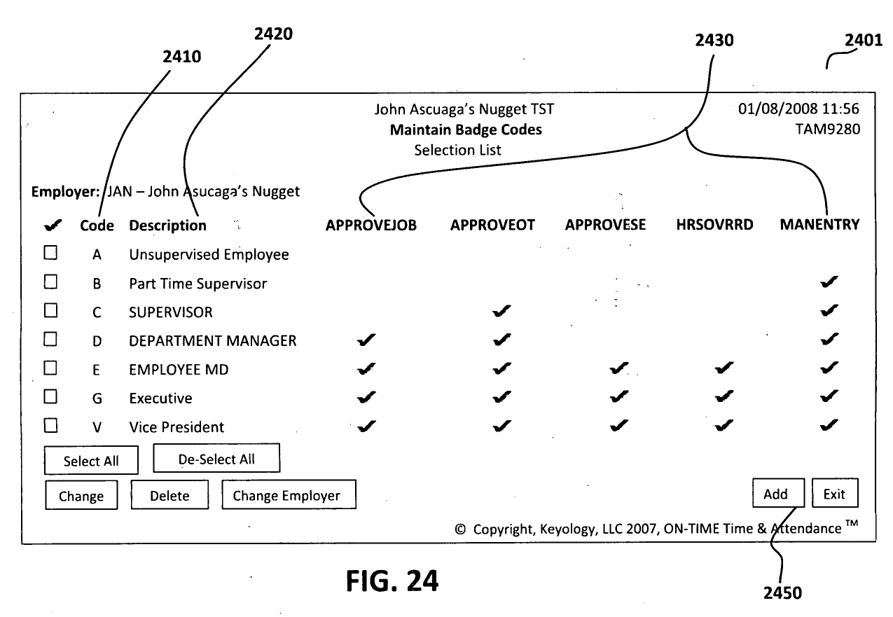

Behind the clock allows for maintenance of badge codes. Each employee will have his or her own badge with a corresponding badge code. At behind the clock, authorized users can create and delete badge codes, and assign varying levels of authorization to each badge code. An example of a maintain badge codes screen 2401 is illustrated in FIG. 24. Badge codes 2410 are listed in the far left column. These badge codes may be any combination of letters and/or numbers, but ideally may be a single character—either an uppercase letter or a one digit number. General badge code descriptions 2420 for each badge code are listed in the next column to the right. In the example illustrated in FIG. 24, badge code “A” corresponds to an “Unsupervised Employee” while badge code “D” corresponds to a department manager. Authorizations granted 2430 lists all types of possible authorizations that may be granted to an employee with a respective badge code. Check marks underneath each authorizations granted label indicate that a certain badge code is authorized for that function. In the FIG. 24 example, Vice Presidents, who have a “V” badge code, are authorized to all functions, while Supervisors, who have a “C” badge code, are authorized only to “APPROVEOT” (approve overtime hours clocked) and “MANENTRY” (manually enter his or her badge code using keypad 310). Any sort of function can be listed at authorizations granted 2430 depending on the type of organization utilizing the time and attendance system. If the authorized user of behind the clock wishes to add an additional badge code, he or she can select Add button 2450. Behind the clock will then advance to an add badge codes screen where the authorized user can input a badge code (“X” for example) and a description of the badge code (“kitchen line cook” for example). Behind the clock authorized users have an ability to add one or more additional authorized functions to a badge code, or subtract one or more additional authorized functions to a badge code. In addition to badge codes, each individual employee and/or supervisor may be assigned an individual (unique) badge number. For example, every employee would have an individual badge number, while a group of employees can be assigned the same badge code indicating that the group is assigned the same authorization levels or authorized functions.

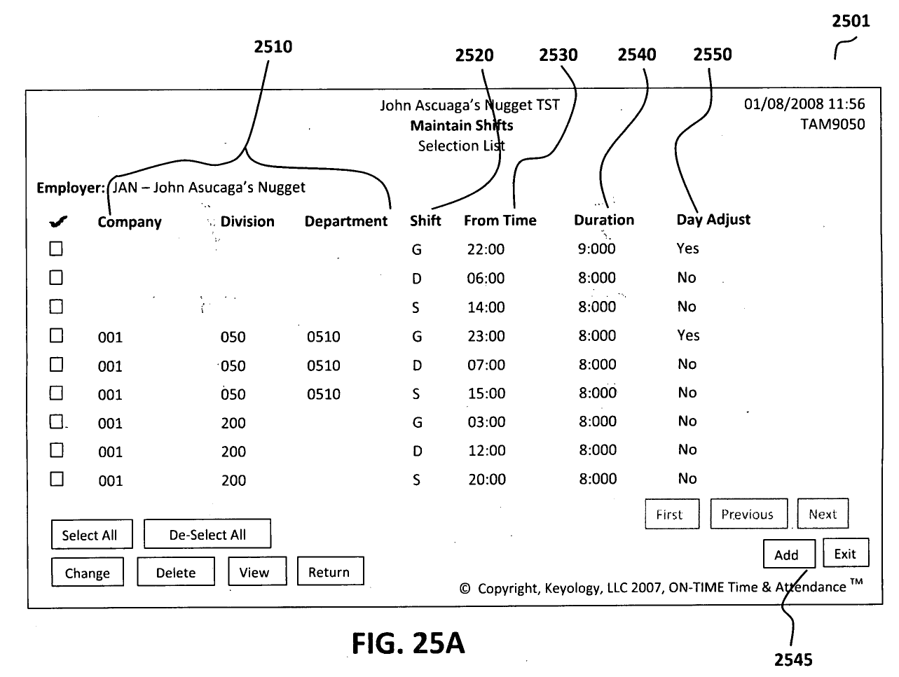

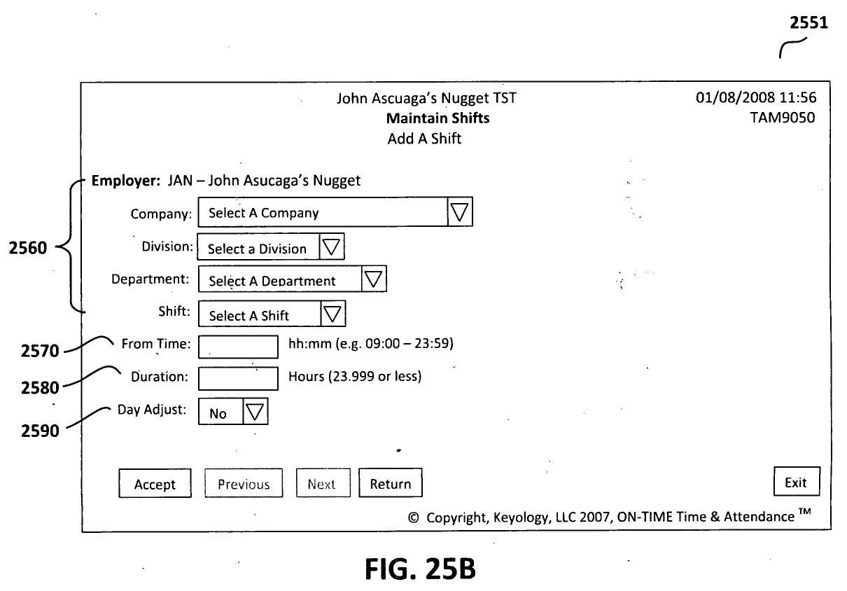

Behind the clock allows authorized users to divide each 24 hour day into shifts. Various items can be configured using behind the clock so that they are affected by shifts, including pay rates. FIG. 25A illustrates a maintain shifts screen 2501. As can be seen at organization or company hierarchy 2510, the time and attendance system allows for creation of a hierarchy within the overall organization, including various levels, such as departments within various divisions within various companies, etc.—with each individual level or unit assigned a particular number or code. This allows different shift schemes, designated by the shift code 2520, to be configured for each unit within the hierarchy. A from time 2530 (meaning the beginning time for each shift), a duration 2540 (meaning the length, in time, of each shift), and a day adjust 2550 (meaning whether the transaction date in the record created for each transaction would be altered for clock ins prior to midnight) can be configured for each shift. To add additional shifts the authorized user would select add button 2545, and behind the clock would advance to add a shift screen 2551. An example of add a shift screen 2551 is illustrated in FIG. 25B. The authorized user would select appropriate organization hierarchy units from drop down menus 2560. This may involve selecting the appropriate company, division, department, and shift at 2560. The authorized user would then enter a from time at from time entry field 2570, a duration at duration entry field 2580, and select either yes or no from a drop down menu at day adjust menu 2590. An authorized user may also be able to alter previously added shifts.

Behind the clock additionally allows for configuration of a holiday schedule and holiday rules. Authorized users can add holiday dates to the holiday schedule, descriptions of those holiday dates, and determine whether each,those holidays will be active (meaning that day will be considered a holiday within the time and attendance system). For example, authorized users can add a holiday date of Mar. 17, 2008, a description for that holiday date of “St. Patrick's Day”, and determine that it will be inactive for the organization. If an employee works on an active holiday date, compensation (or holiday pay rate) can be configured as the organization desires. For example, certain types or departments of employees can be paid time-and-a-half, or double-time, on active holiday dates, while other types or departments of employees are paid their normal wage on active holiday dates. Eligibility can also be configured so that an employee may have to work a predetermined number of days before becoming eligible for holiday compensation rules, or have to work a predetermined number of hours before becoming eligible for holiday compensation rules.

The language displayed on all messaging displayed on a time clock apparatus can be configured for each employee at behind the clock. For example, individual employee badge number can be set so that the language clock messages are displayed in depends upon which employee has swiped in. This functionality can be integrated directly with an organization's exiting human resources software, such as Infinium™. For example, if an employee's preferred language, or native language, is set up and designated in the Infinium™ system, or in a similar human resources system, and that preferred language is a language other than English, the messages on the time clock apparatus can be instantaneously translated at the time that employee swipes his or her badge (or manually enters his or her badge code) and begins using the time and attendance system. In such a case, the human resources system would include some type of code representing the preferred or native language of the employee and cause the time clock apparatus to display any words in information or messages to the employee in the preferred/native language. The words in the preferred/native language could either be stored in a database or translated from one language to another as needed.

This language functionality can be toggled on and off by authorized users at behind the clock. The time and attendance system can either make its own translations with pre-loaded languages, or can take advantage of any language translation functionalities in the accompanying human resources software. Furthermore, individual words and phrases ordinarily displayed on the time clock apparatus employee display screen can be individually, or customarily, translated by authorized users at behind the clock. For example, the phrase “badge code” could be manually translated to an obscure language at behind the clock, so that an employee user who speaks this obscure language can view the phrase “badge code” in his/her own language, even if automatic translation to that language is impractical.

Employee users of a time clock apparatus have an ability to clock in and out of special events, and special events jobs, as described in detail above. These special events must be pre-designated at behind the clock before any employees are able to clock in to them. Authorized users can create a special event by selecting a special event code, writing a description of the special event, and choosing a From Date (beginning date) and To Date (end date). It may also be appropriate to specify specific start and end times with a particular day for the special event. Once pre-designated, the special event may be displayed at special event screen 1701 (see FIG. 17), and the special events jobs may be displayed at special event jobs screen 1801 (see FIG. 18), only during the period of time between the From Date and the To Date. It may additionally be possible for authorized users to toggle pre-designated special events as either active or inactive, so that inactive special events can be stored within the time and attendance system without having to delete them. Both individual employee badge codes, and individual time clock apparatuses, can be configured to either allow clock ins to special events, or to not allow clock ins to special events.

Within the time and attendance system, managers (or supervisors) can be assigned authorization over an employee, a department, a division, or an entire company. Managers can also be assigned authorization over a custom group of employees. Before a manager can be assigned authorization, the manager may be assigned a PIN number. This PIN number is used for manager/supervisor swipe in as described above. The manager may also be assigned a user ID that corresponds to that manager's user ID as recognized in accompanying human resources software. Managers can be given various levels of authority over their subordinates, whether the subordinates are one employee, a department, a division, or an entire company. For example, a manager can be assigned: a level of authority that allows the manager to view hours clocked records of the manager's employees without being able to make changes or view pay rates; or, a level of authority that allows the manager to view hours clocked records of the manager's employees and their pay rates without being able to make changes; or, a level of authority that allows the manager to change select fields within hours clocked records but pay rates are not viewable and cannot be edited; or, a level of authority that allows the manager to change select fields within hours clocked records, view pay rates, and edit pay rates. Other custom or alternative authority levels may be appropriate and will be recognized by those skilled in the art.

As noted, managers as assigned at behind the clock may have various levels of authority to view, change, delete, and/or approve of employee time clock records as created by the time and attendance system. This ability can be referred to as Manager Review. As described above, managers only have access to Manager Review for those employees assigned to the manager in behind the clock. A manager can sort available records by one or more of the following: company, division, and/or department; employee; status; pay period; or specific work day. The manager will be able to view actor some of the following: employee number; employee name; total regular hours worked (as opposed to total hours approved); total overtime hours worked; total other hours worked (such as eligible and active holiday hours); total hours (a sum of total regular hours worked; total overtime hours worked, and total other hours worked); total approved hours; whether a license of a subordinate employee is expired; and what the manager's authority level is over that employee.

Within Manager Review, a manager may have an ability to approve hours clocked by the manager's employees. The manager can approve all hours viewed within Manager Review at once, or can alternatively approve only certain hours based upon the time period within which those hours were clocked or based upon the type of hours (regular, overtime, holiday, special event, etc.). Once hours have been approved by a manager, the transaction records of those hours may be designated within the organization central server 250 as being ready to be sent to (or viewed by) payroll. As described above, Managers can be assigned levels of authority that allow them to edit hour clocked records for their employees. If a manager with such authority wishes to edit, or alter, a transaction record the manager may be required by the time and attendance system to provide a reason for making the edit. Various reasons can be pre-designated at behind the clock and assigned reason codes. Then, when the manager makes an edit or modifies a work record he or she can select a reason from a list of reason codes. All edits/modifications can be recorded and tracked in this way, so that the manager's own manager/supervisor/superior can review all edits for accuracy or legitimacy, etc. Modified work records can then be sent to the organization's payroll system.

Review of work records and/or hours clocked can be facilitated through color-coding. When the work records, or hours clocked, are displayed to a manager or supervisor for review, they can each be color-coded so that the reviewing manager/supervisor can quickly scan a long list of the records. For example, records can be colored green to indicate that the record is ready to be sent to payroll, can be colored yellow to indicate that the record contains hours other than regular hours (such as overtime hours, holiday hours, other hours, etc.), can be colored red to indicate that the record contains disputed hours, can be colored salmon to indicate that the record is for a salaried employee, can be colored white to indicate that the record has been deleted, or can be colored blue to indicate that the record is historical (meaning the record has previously been finalized or dealt with—by sending to payroll, for example).

Finally, behind the clock allows managers and other authorized employees to instantaneously view a list of all employees currently clocked in to the time and attendance system. Depending on the authority level assigned to the manager, the manager may be able to view all employees organization-wide who are currently clocked in, or may only be able to view those subordinate employees who are currently clocked in. A similar functionality may be implemented so that a manager can view all employees, either subordinate to the manager or organization-wide depending on authority assigned at behind the clock, who are currently on-property.

Those skilled in the art will recognize that all permutations of the herein described embodiments and functionalities of the time and attendance systems are possible and intended to be covered by this specification.

While the present invention has been illustrated and described herein in terms of a preferred embodiment and several alternatives associated with time and attendance systems, it is to be understood that the various components of the combination and the combination itself can have a multitude of additional uses and applications. Accordingly, the invention should not be limited to just the particular descriptions and various drawing figures contained in this specification that merely illustrate one or more preferred embodiments and applications of the principles of the invention. Furthermore, all dimensions and calculations are provided only as examples and are not meant to limit this disclosure solely to those conditions.

What is claimed is:

1. A method of tracking and analyzing an employee's time and attendance in real time, comprising the steps of:
receiving an employee identification from the employee through a time clock device among a plurality of time clock devices, the time clock device having an interactive display screen;
receiving a clock in transaction from the employee through the time clock device;
storing the clock in transaction in real-time in a central server communicatively coupled to the time clock device;
receiving a clock out transaction from the employee through the time clock device;
storing the clock out transaction in real-time in the central server;
determining a set of hours worked by the employee based on the clock in transaction and the clock out transaction;
creating a set of hours worked for the employee based on at least the clock in transaction and the clock out transaction, the set of hours worked including a set of regular hours worked if the employee worked regular hours, a set of overtime hours worked if the employee worked overtime hours, and a set of other hours worked by the employee if the employee worked other hours;
displaying the set of hours worked to the employee on the interactive display screen after the clock out transaction;
providing the employee with an opportunity to indicate through the interactive display screen an acceptance of the set of hours worked or a dispute of the set of hours worked;
storing the acceptance or the dispute in the central server;
receiving a supervisor identification from a supervisor through the time clock device if the supervisor is required to authorize an event associated with the employee;
receiving an authorization or a rejection from the supervisor if the supervisor is required to authorize the event;
storing the authorization or the rejection in the central server; and
creating one or more work records for the employee based on the set of hours worked and the acceptance or the dispute, and the authorization or the rejection if received from the supervisor.

2. The method as recited in claim 1, further comprising the steps of:
displaying the one or more work records to the supervisor;
receiving a set of edits to the one or more work records from the supervisor; and
modifying the one or more work records based upon the set of edits to create one or more modified work records.

3. The method as recited in claim 2, further comprising the step of sending the one or more modified work records to a payroll system.

4. The method as recited in claim 2, further comprising the step of providing a color-code to the one or more work records prior to the step of displaying the one or more work records to the supervisor.

5. The method as recited in claim 4, wherein a first color-code indicates that the one or more work records are ready to be sent to payroll, wherein a second color-code indicates that the one or more work records contain a set of overtime hours or a set of other hours, wherein a third color-code indicates that the one or more work records contain one or more disputed hours, wherein a fourth color-code indicates that the one or more work records are for a salaried employee, wherein a fifth color-code indicates that the one or more work records have been deleted, and wherein a sixth color-code indicates that the one or more work records are historical.

6. The method as recited in claim 1, further comprising the step of preventing a second clock in transaction if a last transaction from the employee was the clock in transaction.

7. The method as recited in claim 1, after the step of receiving the clock in transaction, further comprising the step of determining in real-time if the clock in transaction is a first clock in transaction for a shift or a second clock in transaction for the shift, the second clock in transaction for the shift indicating that the employee had already clocked in during the shift without previously clocking out, and wherein the step of storing the employee identification and the clock in transaction includes the step of only storing the first clock in transaction in real-time in the central server.

8. The method as recited in claim 1, further comprising the steps of:
receiving a on break transaction from the employee through the time clock device;
receiving a off break transaction from the employee through the time clock device; and
storing the on break transaction and the off break transaction in real-time in the central server;
wherein the set of hours worked further includes the on break transaction and the off break transaction.

9. The method as recited in claim 1, wherein the clock in transaction is automatically assigned to a normal job for the employee, further comprising the steps of:
receiving a job change transaction for a new job from the employee through the time clock device; and
automatically entering a clock out transaction from the normal job and automatically entering a clock in transaction for the new job upon receipt of the job change transaction;
wherein the set of hours worked further includes the job change transaction, the clock out transaction from the normal job and the clock in transaction for the new job.

10. The method as recited in claim 1, before the step of receiving the clock out transaction, further comprising the step of receiving a declared tips amount from the employee through the time clock device, wherein the set of hours worked includes the declared tips amount.

11. The method as recited in claim 1, after the step of receiving the employee identification, further comprising the steps of:
determining a preferred language for the employee; and
displaying all words on the interactive display system to the employee in the preferred language.

12. The method as recited in claim 11, further comprising the step of displaying one or more messages to the employee.

13. The method as recited in claim 12, wherein the one or more messages include a requirement expiring message for the employee.

14. The method as recited in claim 13, wherein the requirement expiring message is the event requiring the authorization, and further comprising the step of preventing the employee from completing a clock in transaction until the authorization has been received by the time clock device.

15. The method as recited in claim 12, wherein the one or more messages include a requirement expired message for the employee.

16. The method as recited in claim 15, wherein the requirement expired message is the event requiring the authorization, and further comprising the step of preventing the employee from completing a clock in transaction until the authorization has been received by the time clock device.

17. The method as recited in claim 12, wherein the employee is assigned a code, and wherein the one or more messages includes an error message, the error message being based on the code.

18. The method as recited in claim 17, wherein the error message is the event requiring the authorization, and further comprising the step of preventing the employee from completing a clock in transaction until the authorization has been received by the time clock device.

19. The method as recited in claim 1, wherein the employee is assigned a code, and further comprising the steps of:
receiving a job change transaction from the employee through the time clock device;
determining if the job change transaction is permitted by the code; and
permitting the job change transaction if the code permits the job change transaction.

20. The method as recited in claim 19, further comprising the steps of:
determining if the job change transaction requires an authorization;
determining an authorization level among a set of authorization levels;
determining if the authorization meets the authorization level; and
permitting the job change transaction if the authorization meets the authorization level.

21. The method as recited in claim 1, wherein the employee is assigned a code, and further comprising the steps of:
receiving a special event transaction from the employee;
determining if the special event transaction is permitted by the code; and
permitting the special event transaction if the code permits the special event transaction.

22. The method as recited in claim 21, further comprising the steps of:
determining if the special event transaction requires an authorization;
determining an authorization level among a set of authorization levels;
determining if the authorization meets the authorization level; and
permitting the special event transaction if the authorization meets the authorization level.

23. The method as recited in claim 1, wherein the employee can use any time clock device among the plurality of time clock devices as the time clock device.

24. The method as recited in claim 1, further comprising the steps of:
receiving an on property transaction from the employee through the time clock device when the employee enters a property;
storing the on property transaction in real time in the central server;
receiving an off property transaction from the employee through the time clock device when the employee exits the property;
storing the off property transaction in real time in the central server; and
querying the central server during an emergency to determine if the employee is on the property or off the property.

25. The method as recited in claim 1, further comprising the step of modifying an operation of the plurality of time clock devices from the central server.
